(19) United States
(12) Patent Application Publication
(10) Pub. No.: US 2026/0179635 A1
(43) Pub. Date: Jun. 25, 2026

(54) Real-time Speech Enhancement on Raw Signals with Deep State-space Modeling

(71) Applicant: BrainChip, Inc., Laguna Hills, CA (US)

(72) Inventors: Yan Ru PEI, Irvine, CA (US); Ritik SHRIVASTAVA, Laguna Hills, CA (US); SIDHARTH, Laguna Hills, CA (US)

(21) Appl. No.: 19/429,864

(22) Filed: Dec. 22, 2025

Related U.S. Application Data
(60) Provisional application No. 63/737,745, filed on Dec. 22, 2024.

(51) Int. Cl. G10L 21/0208; G10L 25/30

(52) U.S. Cl. CPC G10L 21/0208; G10L 25/30

(57) ABSTRACT

Systems and methods performed by a processor of a computing device for online audio enhancement. Embodiments may include encoding an input audio signal by an encoder of a deep state-space autoencoder based in part on executing a first state-space model (SSM) generating an encoded signal, decoding a signal derived in part from the encoded signal by a decoder of the deep state-space autoencoder based in part on executing a second SSM to generate a decoded signal, and generating an enhanced output signal based in part on executing a third SSM based on the decoded signal.

### CROSS-REFERENCE TO RELATED APPLICATIONS

This application claims the benefit of priority to U.S. Provisional Patent Application No. 63/737,745 entitled “Real-time Speech Enhancement on Raw Signals with Deep State-space Modeling” filed Dec. 22, 2024, the entire contents of which are hereby incorporated by reference for all purposes.

### TECHNICAL FIELD

The present disclosure generally relates to the fields of artificial intelligence and machine learning. In particular, the present disclosure relates to neural networks and deep learning models, including state-space models. Some aspects of the present disclosure may relate to real-time audio processing techniques, including denoising, super-resolution, and dequantization of audio signals. Some aspects may relate to computing devices configured to perform audio enhancement, including edge devices and resource-constrained systems.

### BACKGROUND

Speech enhancement technologies address the challenge of processing audio signals to improve intelligibility and quality for various applications. These technologies play a role in human-to-human communication systems, such as hearing aids, as well as human-to-machine interfaces, such as automatic speech recognition (ASR) systems. Many speech enhancement techniques are designed to mitigate the effects of background noise and other distortions in audio signals.

The processing of speech signals presents unique challenges due to the dynamic and complex nature of speech patterns. Background noise, which may vary significantly in type and intensity, introduces variability that complicates the task of isolating and enhancing speech content. Audio signal processing systems often operate on dense data samples, which may require techniques that address computational resource constraints while maintaining perceptual fidelity.

Traditional speech enhancement methods use algorithmic approaches such as Wiener filtering, spectral subtraction, and principal component analysis. These techniques rely on mathematical models to process and reconstruct speech signals. More recent developments in audio processing leverage machine learning techniques, including deep learning models, to address non-linearities in speech and noise patterns. Machine learning approaches have been explored for their ability to model complex relationships within audio data, including time-domain and frequency-domain representations. Such techniques may be particularly useful in environments in which real-time or high-quality speech processing is beneficial.

Despite advances in signal processing and machine learning, speech enhancement remains a technically challenging area, particularly in resource-constrained devices, non-stationary noise environments, and real-time applications. Research in this field continues to focus on improving the efficiency, accuracy, and adaptability of speech enhancement technologies across a range of use cases.

### SUMMARY

The various aspects include methods for implementing a deep state-space autoencoder configured for efficient online audio enhancement on a computing device. Some aspects include methods of online audio enhancement that include receiving an input audio signal, generating a first encoded signal by executing an encoder of a deep state-space autoencoder, which may include executing a first state-space model (SSM) layer to transform the input audio signal, generating a first decoded signal by executing a decoder of the deep state-space autoencoder, which may include executing a second SSM layer to transform a signal derived from the first encoded signal, and generating an enhanced output audio signal by processing the first decoded signal with a postprocessing layer.

Some aspects may further include generating the signal derived from the first encoded signal as a first combined signal by combining the first encoded signal with a second decoded signal having a temporal resolution matching the first encoded signal, and generating the first decoded signal by decoding the first combined signal. Some aspects may further include generating a first up-sample signal by up-sampling the second decoded signal to a temporal resolution matching the first encoded signal, and generating the first combined signal by combining the first encoded signal with the first up-sample signal. Some aspects may further include generating a second encoded signal by encoding the first encoded signal by executing the encoder which may include executing a third SSM layer, generating a second combined signal by combining the second encoded signal with a third decoded signal having a temporal resolution matching the second encoded signal, and generating the second decoded signal by decoding the second combined signal by executing the decoder which may include executing a fourth SSM layer.

Some aspects may further include generating a first down-sample signal by down-sampling the first encoded signal, generating the second encoded signal by encoding the first down-sample signal, generating a second up-sample signal by up-sampling the third decoded signal to a temporal resolution matching the second encoded signal, and generating the second combined signal by combining the second encoded signal with the second up-sample signal. Some aspects may further include generating a second encoded signal by encoding the first encoded signal by executing the encoder which may include executing a third SSM layer, generating a bottleneck signal by processing the second encoded signal with a bottleneck layer which may include executing a fourth SSM layer, generating a bottleneck combined signal by combining the second encoded signal with the bottleneck signal at a matching temporal resolution, and generating a second decoded signal by decoding the bottleneck combined signal by executing the decoder which may include executing a fifth SSM layer.

Some aspects may further include generating a first down-sampled signal by down-sampling the first encoded signal, generating the second encoded signal by encoding the first down-sampled signal, generating a second down-sampled signal by down-sampling the second encoded signal, generating the bottleneck signal by processing the second down-sampled signal with the bottleneck layer, generating a first up-sample signal by up-sampling the bottleneck signal to a temporal resolution matching the second encoded signal, and generating the bottleneck combined signal by combining the second encoded signal with the first up-sample signal. Some aspects may further include generating a pre-convolution output by filtering the input audio signal with a pre-convolution layer executed by the encoder, generating an encoder SSM output by executing the first SSM layer on the pre-convolution output, generating an encoder normalization output by normalizing activations with a normalization layer executed by the encoder on the encoder SSM output, and generating the first encoded signal by applying a linear unit layer executed by the encoder to the encoder normalization output. Some aspects may further include generating a decoder SSM output by executing the second SSM layer on the signal derived from the first encoded signal, generating a decoder normalization output by normalizing activations with a normalization layer executed by the decoder on the decoder SSM output, and generating the first decoded signal by applying a linear unit layer executed by the decoder to the decoder normalization output.

Some aspects may further include generating the enhanced output audio signal by filtering the first decoded signal with a causal convolution executed by the postprocessing layer to reduce forward-looking latency. Some aspects may further include representing the input audio signal as a raw time-domain waveform and representing the enhanced output audio signal as a raw time-domain waveform. Some aspects may further include representing the input audio signal as a frequency-domain representation derived from a raw time-domain waveform, and representing the enhanced output audio signal as a frequency-domain representation.

Further aspects include methods of online audio enhancement, which may include receiving an input audio signal which may include a time-ordered sequence of audio sample values, generating encoded audio features by executing an encoder of a deep state-space autoencoder, which may include maintaining a first hidden state of a first state-space model (SSM) layer having a fixed state dimension and updating the first hidden state based on successive audio sample values, storing at least a portion of the encoded audio features as a skip connection feature set, generating decoder input features by transforming the encoded audio features, generating decoded audio features by executing a decoder of the deep state-space autoencoder, which may include maintaining a second hidden state of a second SSM layer having a fixed state dimension and updating the second hidden state based on successive decoder input feature values, generating combined decoded audio features by combining the skip connection feature set with a decoded audio feature subset having a temporal resolution matching the skip connection feature set, and generating an enhanced output audio signal by processing the combined decoded audio features with a postprocessing layer which may include a causal convolution to output a time-ordered sequence of enhanced audio sample values.

Some aspects may further include generating down-sampled encoded audio features by down-sampling the encoded audio features according to a resampling factor, generating bottleneck audio features by processing the down-sampled encoded audio features with a bottleneck layer of the deep state-space autoencoder, generating up-sampled bottleneck audio features by up-sampling the bottleneck audio features according to an inverse resampling factor corresponding to the resampling factor, and assigning the up-sampled bottleneck audio features as the decoder input features. Some aspects may further include generating a plurality of encoded audio feature sequences at a plurality of temporal resolutions by iteratively down-sampling and encoding within a plurality of encoder blocks of the encoder, generating a plurality of skip connection feature sets by storing a respective skip connection feature set from each encoded audio feature sequence of the plurality of encoded audio feature sequences, generating a plurality of decoded audio feature sequences at the plurality of temporal resolutions by iteratively up-sampling and decoding within a plurality of decoder blocks of the decoder, and generating the combined decoded audio features by combining, for each temporal resolution of the plurality of temporal resolutions, a respective skip connection feature set with a respective decoded audio feature sequence.

Some aspects may further include generating the combined decoded audio features by performing an elementwise addition operation between the skip connection feature set and the decoded audio feature subset. Some aspects may further include generating a pre-convolution output by filtering the sequence of audio sample values with a depthwise one-dimensional causal convolution, and generating the encoded audio features by providing the pre-convolution output to the first SSM layer. Some aspects may further include generating a state-space output by executing the first SSM layer while generating the encoded audio features, generating a normalized state-space output by normalizing the state-space output with a normalization layer, and generating the encoded audio features by applying a linear unit layer to the normalized state-space output. Some aspects may further include generating the normalized state-space output by performing layer normalization on the state-space output. Some aspects may further include maintaining the first hidden state as a complex-valued state vector, generating a real-valued state-space output by extracting a real component of the complex-valued state vector, and generating the encoded audio features by processing the real-valued state-space output. Some aspects may further include representing the input audio signal as a time-domain waveform, representing the enhanced output audio signal as a time-domain waveform, and omitting a short-time Fourier transform and an inverse short-time Fourier transform. Some aspects may further include representing the input audio signal as a frequency-domain representation derived from a time-domain waveform, and representing the enhanced output audio signal as a frequency-domain representation.

Some aspects may further include outputting the enhanced output audio signal as at least one of a denoised audio signal, a super-resolution audio signal, or a dequantized audio signal. Some aspects may further include identifying an input sampling rate of the input audio signal, and generating the enhanced output audio signal at an output sampling rate higher than the input sampling rate. Some aspects may further include identifying an input bit depth of the input audio signal, generating decoded input values by decoding mu-law companded values of the input audio signal to linear amplitude values, generating normalized input sample values by scaling the decoded input values to a normalized amplitude range, assigning the normalized input sample values as the sequence of audio sample values, and generating the sequence of enhanced audio sample values with an output bit depth higher than the input bit depth.

Further aspects may include a computing device having at least one processor or processing system configured with processor-executable instructions to perform various operations corresponding to the methods discussed above. Further aspects may include a computing device having various means for performing functions corresponding to the method operations discussed above. Further aspects may include a non-transitory processor-readable storage medium having stored thereon processor-executable instructions configured to cause at least one processor or processing system to perform various operations corresponding to the method operations discussed above.

### BRIEF DESCRIPTION OF FIGURES

The accompanying drawings, which are incorporated herein and constitute part of this specification, illustrate exemplary aspects of the invention and, together with the general description given above and the detailed description given below, serve to explain the features of the invention.

FIG. 1 is a component diagram of an on-chip system (SOC) suitable for implementing some embodiments.

FIG. 2A-2H are component block diagrams illustrating an example deep state-space autoencoder configured for efficient online audio enhancement in accordance with some embodiments.

FIG. 3 is a graph diagram illustrating exemplary results of testing an example deep state-space autoencoder configured for efficient online audio enhancement in accordance with some embodiments.

FIGS. 4A and 4B are process flow diagrams illustrating example flows/methods for implementing a deep state-space autoencoder configured for efficient online audio enhancement in accordance with some embodiments.

FIGS. 5A and 5B are process flow diagrams illustrating example flows/methods for implementing a deep state-space autoencoder configured for efficient online audio enhancement in accordance with some embodiments.

FIG. 6 is a component block diagram illustrating an example edge computing device in the form of a headset that is suitable for implementing some embodiments.

FIG. 7 is a component block diagram illustrating an example edge computing device in the form of a laptop that is suitable for implementing some embodiments.

FIG. 8 is a component diagram of a server suitable for implementing some embodiments.

### DETAILED DESCRIPTION

The various embodiments may be described in detail with reference to the accompanying drawings. Wherever possible, the same reference numbers may be used throughout the drawings to refer to the same or like parts. References made to particular examples and implementations are for illustrative purposes and are not intended to limit the scope of the invention or the claims.

The word “exemplary” may be used herein to mean “serving as an example, instance, or illustration.” Any implementation described herein as “exemplary” is not necessarily to be construed as preferred or advantageous over other implementations.

In overview, the embodiments include methods, state machines, processing systems, and computing devices configured to perform efficient online audio enhancement using a deep state-space autoencoder. Some embodiments may address technical challenges associated with computational and memory resource limitations encountered in previous approaches to online audio enhancement. Some embodiments may provide improved real-time denoising, super-resolution, or de-quantization of audio signals to deliver enhanced audio quality, reduced processing latency, and more efficient power and memory utilization on computing devices.

Some embodiments may include a system for audio enhancement that includes denoising, super-resolution, and dequantization. Super-resolution may include increasing the sampling frequency of audio intelligently so as to allow lower-frequency audio to be upsampled to higher frequencies. Dequantization may include converting audio recorded at a low bit depth, such as 4 bits, to a higher bit depth, such as 16 bits, to enhance audio quality. In some embodiments, the system may process raw audio directly in an end-to-end manner. This may eliminate the need for traditional preprocessing or postprocessing transformations such as Fourier transforms.

Some embodiments may include processing raw audio inputs directly and producing raw audio outputs. By avoiding spectral domain transformations, the system may reduce computational costs, power consumption, and latency while achieving efficient real-time performance. In some embodiments, the system may be configured to explicitly prioritize raw audio processing to reduce computational costs, power consumption, and processing latency. By eliminating Fourier transforms or other spectral domain transformations, the system may achieve enhanced real-time performance on power-constrained devices. In some embodiments, these features may be implemented using a deep state-space autoencoder that uses state-space models (SSMs) as a type of recurrent network that supports efficient training on parallel hardware (e.g., GPUs, etc.) and streamlined inference for resource-constrained devices.

The term “computing device” may be used herein to refer to devices that include memory and programmable processors capable of executing machine learning algorithms or other computational tasks to provide the functionality described herein. Examples of computing devices include server computing devices, personal computing devices, desktop computers, laptops, tablets, smartphones, wearable devices (e.g., smartwatches, earphones, hearing aids), Internet of Things (IoT) devices (e.g., smart speakers, smart thermostats, smart home hubs, smart displays), connected vehicles, autonomous vehicles, drones, and audio devices (e.g., smart speakers).

The term “processing system” may be used herein to refer to one or more processors, including multi-core processors, that are organized and configured to perform various computing functions. Various embodiment methods may be implemented in one or more of multiple processors within a processing system of a computing device, as described herein.

The term “system on chip” (SoC) is used herein to refer to a single integrated circuit (IC) chip that contains multiple resources or independent processors integrated on a single substrate. A single SoC may contain circuitry for digital, analog, mixed-signal, and radio-frequency functions. A single SoC may include at least one processor of a processing system that includes any number of general-purpose or specialized processors (e.g., network processors, digital signal processors, modem processors, video processors, etc.), memory blocks (e.g., ROM, RAM, Flash, etc.), and resources (e.g., timers, voltage regulators, oscillators, etc.). For example, an SoC may include an applications processor that operates as the SoC's main processor, central processing unit (CPU), microprocessor unit (MPU), arithmetic logic unit (ALU), etc. An SoC processing system may also include software for controlling integrated resources and processors, as well as for controlling peripheral devices.

The term “system in a package” (SIP) is used herein to refer to a single module or package that contains multiple resources, computational units, cores, or processors on two or more IC chips, substrates, or SoCs. For example, a SIP may include a single substrate on which multiple IC chips or semiconductor dies are stacked vertically. Similarly, the SIP may include one or more multi-chip modules (MCMs) on which multiple ICs or semiconductor dies are packaged into a unifying substrate. An SIP may also include multiple independent SOCs coupled together via high-speed communication circuitry and packaged in close proximity, such as on a single motherboard, in a single UE, or in a single CPU device. The proximity of the SoCs facilitates high-speed communications and the sharing of memory and resources.

The terms “machine learning algorithm” and “artificial intelligence model” and the like may be used interchangeably herein to refer to a variety of computational models or information structures that may be used by a computing device to perform tasks, computations, or evaluations. Examples of machine learning algorithms include neural network models, inference models, classifiers, random forest models, spiking neural network (SNN) models, convolutional neural network (CNN) models, recurrent neural network (RNN) models, state-space models (SSMs), deep neural network (DNN) models, generative adversarial networks (GANs), ensemble networks, and genetic algorithm models. In some embodiments, a machine learning algorithm may include an architectural definition (e.g., neural network architecture) and corresponding weights (e.g., neural network weights).

The term “neural network” may be used herein to refer to an interconnected group of processing nodes (or neuron models) that collectively operate as a software application or process that controls a function of a computing device and generates an overall inference result as output. Individual nodes in a neural network may attempt to emulate biological neurons by receiving input data, performing simple operations on the input data to generate output data, and passing the output data (also called “activation”) to the next node in the network. Each node may be associated with a weight value that defines or governs the relationship between input data and output data. A neural network may learn to perform new tasks over time by adjusting these weight values. In some cases, the overall structure of the neural network and the operations of the processing nodes do not change as the neural network learns a task. Rather, learning is accomplished during a “training” process in which the values of the weights in each layer are determined. As an example, the training process may include causing the neural network to process a task for which an expected/desired output is known, comparing the activations generated by the neural network to the expected/desired output, and determining the values of the weights in each layer based on the comparison results. After the training process is complete, the neural network may begin “inference” to process a new task with the determined weights.

The term “inference” may be used herein to refer to a process that is performed at runtime or during the execution of the software application program corresponding to the machine learning algorithm. Inference may include traversing the processing nodes in a network (e.g., neural network, etc.) along a forward path (which may include some backward traversals) to produce one or more values as an overall activation or overall “inference result.”

The term “deep neural network” may be used herein to refer to a neural network that implements a layered architecture in which the output/activation of a first layer of nodes becomes an input to a second layer of nodes, the output/activation of a second layer of nodes becomes an input to a third layer of nodes, and so on. As such, computations in a deep neural network may be distributed over a population of processing nodes that make up a computational chain. Deep neural networks may also include activation functions and sub-functions between the layers. The first layer of nodes of a multilayered or deep neural network may be referred to as an input layer. The final layer of nodes may be referred to as an output layer. The layers in between the input and final layers may be referred to as intermediate layers.

The term “recurrent neural network” (RNN) may be used herein to refer to a class of neural networks particularly well-suited for sequence data processing. Unlike feedforward neural networks, RNNs may include cycles or loops within the network that allow information to persist. This enables RNNs to maintain a “memory” of previous inputs in the sequence, which may be beneficial for tasks in which temporal dynamics and the context in which data appears are relevant.

The term “state-space model” (SSM) may be used herein to refer to a type of computational model particularly well-suited for handling sequence data by maintaining a compact hidden state that evolves based on the input data. SSMs process input data serially, updating the hidden state at each step, where the hidden state captures all prior information without increasing in size as more data is processed. SSMs may capture long-range temporal relationships of variables by evolving dependencies between input variables, state or internal variables, and output variables with stable linear recurrent units. SSMs may be distinct from traditional recurrent neural networks (RNNs) because, for example, they offer more efficient memory usage. In some embodiments, SSMs may be integrated with machine learning algorithms for more efficient processing of large datasets, including raw speech inputs, while reducing resource usage requirements. SSMs may be particularly beneficial in systems that benefit from real-time sequence processing, including online raw speech enhancement systems and other advanced AI-driven applications.

The term “pre-convolution” may be used herein to refer to a type of process configured to prepare or transform input data before it undergoes further processing operations of a deep neural network. Pre-convolution processing may include tasks such as normalizing the input data, resizing or cropping input data, augmenting the input data, applying filters to emphasize certain features, etc. Pre-convolution processing may configure the input data in a manner that facilitates more efficient or accurate feature extraction during the subsequent processing operations of the deep neural network. By improving the quality and consistency of input data, pre-convolution processing may contribute to better model performance, helping learning models detect patterns and features with greater precision.

The term “normalization” may be used herein to refer to a type of process configured to scale input data or activations within a learning model to a standardized range. The goal of normalization may be to stabilize and speed up training by reducing internal covariate shift, the change in input distribution to a layer during training. Normalization may refer to layer normalization, which may be a type of process configured for normalizing across features of each data instance. Normalization may refer to batch normalization, which may be a type of process configured for normalizing the inputs to each layer within a batch of the inputs.

The term “linear unit” may be used herein to refer to a type of process configured to implement linear or piecewise linear transformation of input data by scaling the input data linearly (or near-linearly) and applying non-linear activation functions to the outputs of neurons or layers. Non-linearity may allow a neural network to learn complex patterns and relationships within the data that go beyond linear combinations. A non-linear unit may refer to a sigmoid linear unit (SiLU) configured to apply a sigmoid function to the outputs. A non-linear unit may refer to a rectified linear unit (ReLU) configured to apply a rectification function to the outputs, limiting the values of the outputs to 0 for negative values and allowing for positive values of the outputs.

The term “deep state-space autoencoder” may be used herein to refer to a specialized neural network component configured to perform tasks such as efficient online audio enhancement. A deep state-space autoencoder may include an encoder, a bottleneck module, and a decoder that work together to process input signals and generate enhanced outputs. The deep state-space autoencoder may use state-space models (SSMs) to capture long-range temporal relationships within input data, such as speech signals, using compact and stable linear recurrent units. The deep state-space autoencoder may use SSM layers to achieve efficient real-time processing with reduced latency, computational demands, and memory usage. In some embodiments, the deep state-space autoencoder may process raw waveforms directly to eliminate the need for spectral domain transformations such as short-time Fourier transforms (STFTs). In some embodiments, the deep state-space autoencoder may process waveforms transformed by spectral domain transformations such as STFTs.

The term “denoising” may be used herein to refer to the process of reducing or removing noise from an input signal to enhance its quality and intelligibility. Denoising may include identifying and suppressing unwanted components, such as background noise, while preserving the desired features of the original signal. Denoising may be used in speech enhancement to improve the clarity and naturalness of spoken words, even in challenging environments with non-stationary noise. In some embodiments, denoising may be performed using machine learning algorithms, such as state-space models (SSMs) or other neural network architectures, that analyze input signals and generate corresponding enhanced outputs. In some embodiments, denoising operations may be applied in real-time to support applications such as telecommunication, hearing aids, automatic speech recognition, and audio recording systems.

The term “raw audio processing” may be used herein to refer to processor-executable operations that include receiving audio signals in their native, untransformed time-domain representation and directly processing them through the autoencoder to generate enhanced outputs. Some embodiments may perform raw audio processing so as to avoid the computational overhead of transformations such as short-time Fourier transforms (STFTs) or inverse STFTs. The autoencoder may be configured to process raw time-domain waveforms directly to prioritize computational efficiency and energy savings. Some embodiments may include an autoencoder that is configured to support the processing of pre-transformed audio signals, such as spectrogram inputs, as an optional feature. Some embodiments may use raw audio input to improve power efficiency and thus may be even more well-suited for use in mobile and edge devices with constrained resources.

The various embodiments include methods, state machines, processing systems, and computing devices configured to implement the methods for configuring, deploying, and operating a deep state-space autoencoder designed for efficient online audio enhancement on computing devices. Some embodiments may address technical challenges associated with online audio enhancement, particularly those related to improving real-time denoising, super-resolution, or de-quantization performance, enhancing audio quality, and reducing both processing latency and the computational and memory resource demands on computing devices. The various embodiments may be similarly executed for various audio signals, including raw audio signals or audio signals transformed to a frequency domain. The various embodiments may also be similarly executed for various types of audio, including speech, music, mechanical sounds, animal sounds, natural environmental sounds, etc.

For clarity and brevity, some of the descriptions and examples herein primarily reference raw speech audio. However, such references should not be used to limit the scope of the specification or claims to raw audio signals or speech-type audio unless expressly recited as such in the claims.

Traditional speech enhancement methods, such as Wiener filtering, spectral subtraction, and principal component analysis, may perform adequately in stationary noise environments. However, their effectiveness decreases significantly in non-stationary noise scenarios, often introducing artifacts, such as musical noises, and causing substantial degradation in the quality and intelligibility of enhanced speech.

Deep learning-based audio denoising methods address some of these limitations by leveraging large datasets of paired clean and noisy audio signals. These methods aim to model the nonlinear relationship between clean and noisy signal features without relying on prior knowledge of noise statistics, which may be required by conventional solutions. Speech features for these models may be extracted from either real or complex spectrograms of the noisy signal in the time-frequency domain or directly from the raw waveform.

Many deep learning denoising models use the feature extraction capabilities of convolutional neural networks (CNNs). For example, the UNet convolutional encoder-decoder architecture is commonly used in models such as Deep Complex UNet and the speech enhancement generative adversarial network (SEGAN). However, CNNs generally lack the ability to model long-range temporal dependencies inherent in speech signals. To address this technical challenge, recurrent neural networks (RNNs) have been used, as demonstrated by models such as the deep complex convolutional recurrent network (RDCCRN) and the frequency recurrent convolutional recurrent network (FRCRN). While these discriminative models may better capture temporal dependencies, they often exhibit limited robustness to varying noise types and generalization across diverse audio sources.

Likelihood-based generative models, such as denoising diffusion probabilistic models (DDPMs), treat denoising as a conditional generation problem, providing improved generalization to previously unseen noise conditions. Together with variational autoencoders, DDPMs represent an unsupervised class of models that promise enhanced generalization to diverse noise and acoustic scenarios. However, these approaches typically involve a large number of parameters, resulting in high computational costs. Further, their nonlinear and recurrent nature may limit their ability to efficiently utilize parallel hardware (e.g., GPUs, etc.) during training.

Alternative approaches, such as PercepNet and RNNoise, attempt to reduce network size and complexity by combining traditional speech enhancement techniques with deep learning methods. These approaches may result in smaller models with fewer parameters to support real-time performance on general-purpose hardware. Similarly, methods that process raw waveform signals aim to enhance the expressive capabilities of deep networks while avoiding computationally expensive time-frequency transformations. For example, the deep extractor for music sources (DEMUCS) demonstrates effective real-time performance, but other models, such as CleanUNet, face challenges performing real-time inference on general-purpose hardware. Models like DeepFilterNet may exploit speech-specific properties, such as short-term speech correlations, to achieve results comparable to those of more complex architectures.

Some embodiments include computing devices equipped with a processing system that is configured to address these and other challenges of traditional and deep learning-based speech enhancement by implementing a deep state-space autoencoder configured for efficient online audio enhancement. The deep state-space autoencoder may use state-space models (SSMs) to capture long-range temporal relationships in speech signals using stable linear recurrent units. Capturing long-range correlations may allow the system to model global speech patterns, identify noise profiles, and implicitly capture semantic contexts to enhance speech enhancement performance.

Some embodiments may include state-space layers that are configured for efficient training and inference. These layers may support real-time inference with reduced latency and a simplified architecture that reduces or minimizes computational demands by reducing the number of parameters and multiply-accumulate (MAC) operations. In addition, the deep state-space autoencoder may process raw audio waveforms directly, which may eliminate the need for pre-processing or post-processing steps and further improve efficiency in online speech enhancement applications.

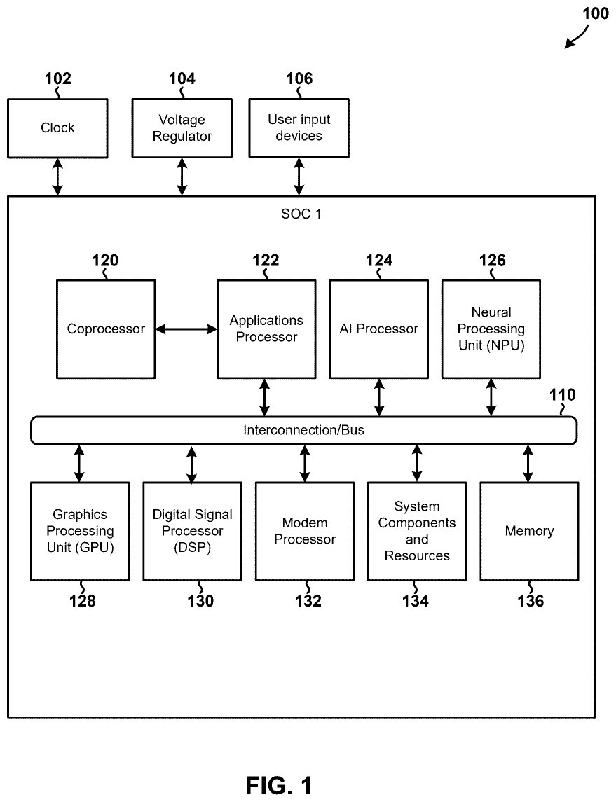

Various embodiments may be implemented in single-processor or multiprocessor computer systems, including a system-on-chip (SoC) or system-in-package (SiP). FIG. 1 illustrates an example computing system or SoC 100 architecture that may be included in edge devices implementing the various embodiments.

In the example illustrated in FIG. 1, the SoC 100 includes a clock 102, voltage regulator 104, and user input devices 106 (e.g., touch-sensitive displays, microphones, cameras). The SoC 100 integrates various processors, including a coprocessor 120 (e.g., vector coprocessor), applications processor 122, AI processor 124, and neural processing unit (NPU) 126. Additional components include the graphics processing unit (GPU) 128, digital signal processor (DSP) 130, modem processor 132, memory 136, and system components and resources 134. The processors and components may be interconnected via an interconnection/bus 110, which may utilize advanced interconnect technologies such as high-performance networks-on-chip (NoCs), reconfigurable logic arrays, or bus architectures like CoreConnect or AMBA.

In some embodiments, any of the processors 120-132 in the SoC 100 may function as the central processing unit (CPU), microprocessor unit (MPU), or arithmetic logic unit (ALU). The SoC 100 may execute software programs, performing arithmetic, logical, control, and input/output (I/O) operations as specified by program instructions (e.g., processor-executable instructions, etc.). One or more of the coprocessors 120 may be configured to assist the CPU in these operations.

Each processor 120-132 may include one or more cores, and each processor/core may perform operations independent of the other processors/cores. For example, the SOC 100 may include a processor that executes a first type of operating system (e.g., FreeBSD, LINUX, etc.) and a processor that executes a second type of operating system (e.g., OS X, etc.).

In some embodiments, any or all of the processors 120-132 may be part of a processing cluster, such as a heterogeneous processor cluster architecture. In some embodiments, any or all of the processors 120-132 may operate as part of CPU clusters, with interconnected nodes (e.g., cores, processors, SoCs) working in coordination to perform computational tasks. Each node may have its own operating system, CPU, memory, and storage. A computational task may be divided among these nodes, allowing for parallel processing. The results from each node's computation may be combined to produce a final result (often faster compared to a single processor). CPU clusters also offer greater reliability and resilience against failures due to their distributed architecture.

The SoC 100 includes various system components and resources for managing sensor data, wireless transmissions, analog-to-digital conversions, and other specialized tasks, such as performing AI inference or precomputing hidden states for frequently used input text. These components may include power amplifiers, voltage regulators, oscillators, phase-locked loops, data controllers, memory controllers, and peripheral bridges. The system components also facilitate communication with peripheral devices such as cameras, microphones, external displays, and wireless communication modules.

The SoC 100 may further include an input/output (I/O) module (not shown) for interfacing with external resources such as the clock 102, voltage regulator 104, user input devices 106, and wireless transceivers (e.g., Bluetooth, cellular transceivers). These external resources may be shared among multiple processors or cores within the SoC 100.

In addition to the SoC 100, various embodiments may be implemented in other computing systems, including those with single or multicore processors, multiple processors, or hybrid configurations that integrate different processing technologies.

Some embodiments may include a deep state-space autoencoder that is configured to perform efficient online audio enhancement in an end-to-end manner. The performance of the deep state-space autoencoder may be evaluated primarily on its ability to denoise raw speech, with additional assessments on tasks such as super-resolution and de-quantization. Compared to previous real-time denoising models, the deep state-space autoencoder may provide benefits and enhancements in areas such as higher perceptual evaluation of speech quality (PESQ) scores, reduced parameter counts, decreased multiply-accumulate (MAC) operations, and lower latency.

The deep state-space autoencoder may be configured to process raw or frequency domain transformed waveforms and maintain high fidelity to clean audio signals while reducing or minimizing audible artifacts. Further, deep state-space autoencoder architecture may demonstrate robust performance even when processing compressed noisy inputs, such as audio sampled at 4000 Hz with 4-bit resolution. As such, the deep state-space autoencoder may enhance speech in resource-constrained computing devices and environments with constrained computational and memory resources.

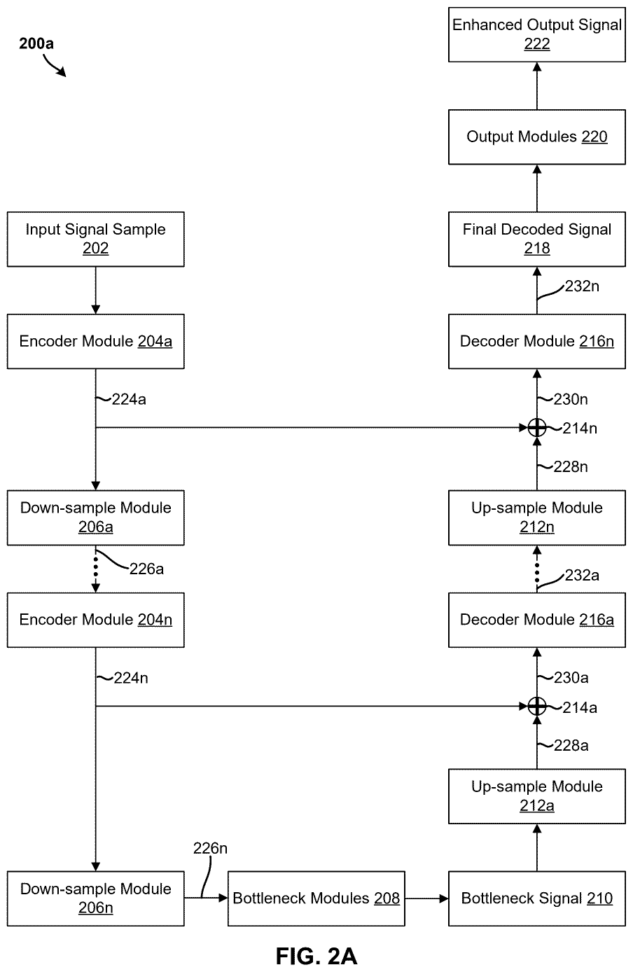

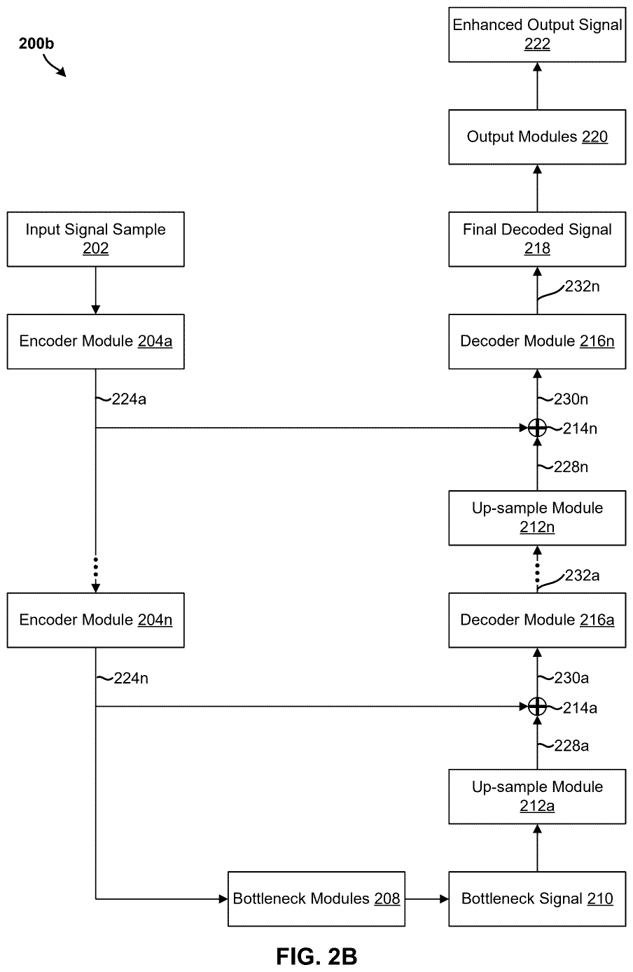

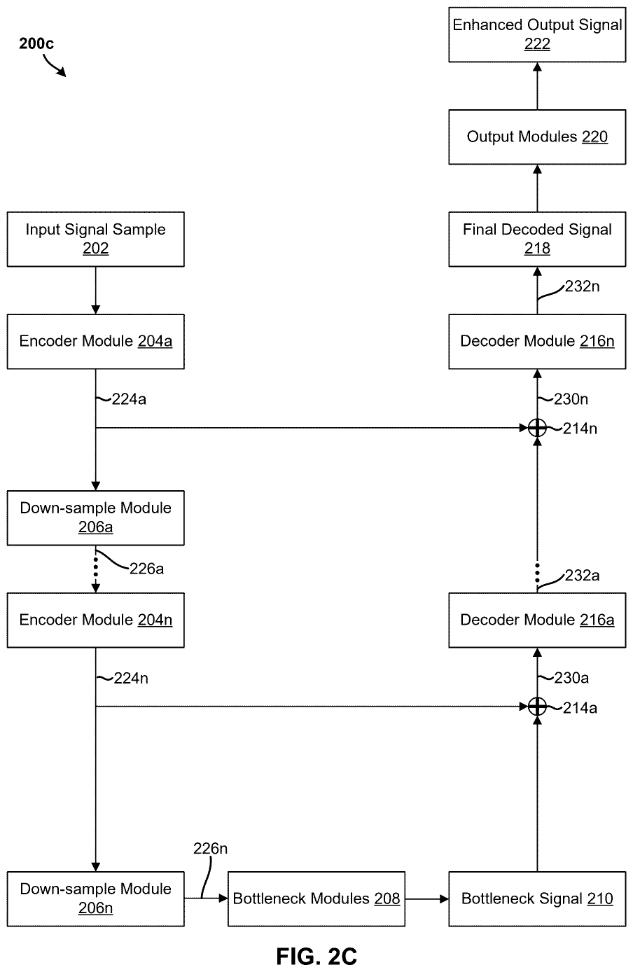

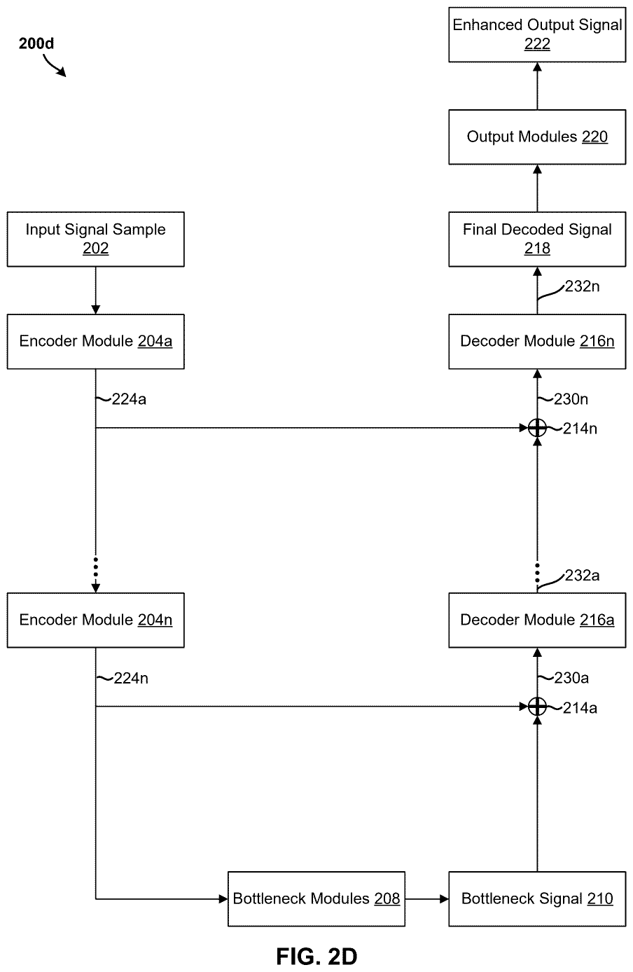

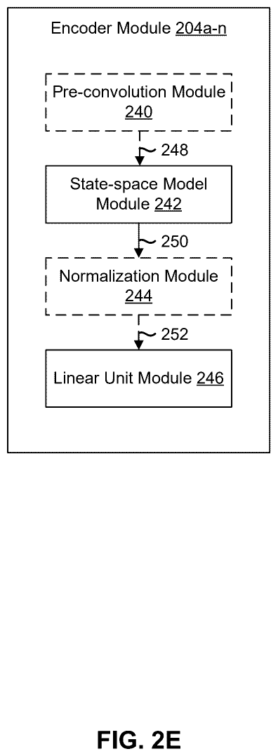

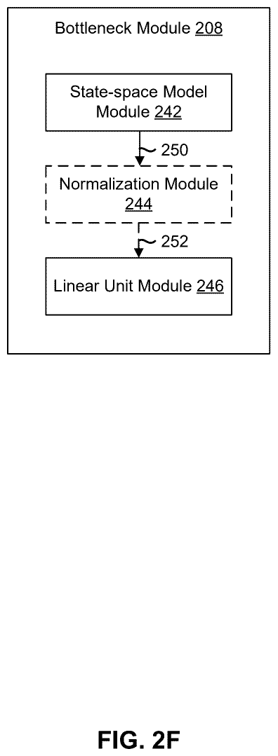

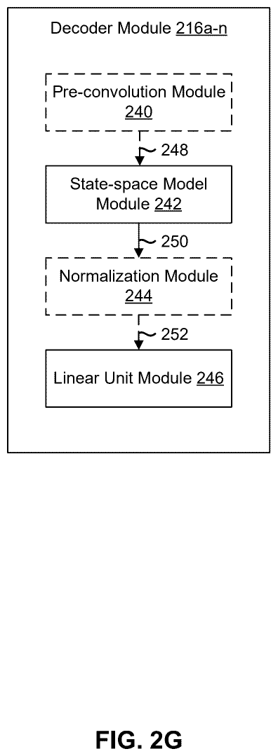

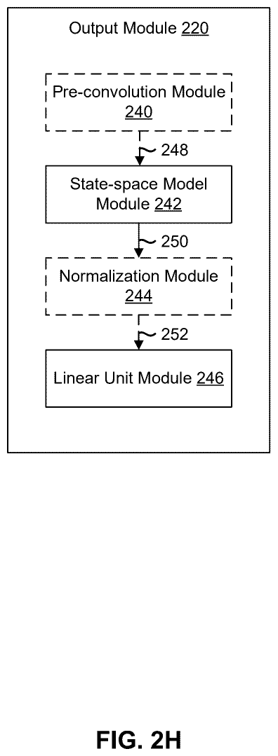

FIGS. 2A-2H illustrate deep state-space autoencoders 200a-200d configured for efficient online raw speech enhancement in accordance with some embodiments. The deep state-space autoencoders 200a-200d may be configured as hardware integral to or separate from the SoC 100 or software stored on memory 136 and executed by a processing system, including one or more processors 120-132. The deep state-space autoencoders 200a-200d may include various modules, such as encoder modules 204a-204n, down-sample modules 206a-206n, bottleneck modules 208, up-sample modules 212a-212n, decoder modules 216a-216n, output modules 220, and combination modules 214a-214n, configured as the hardware or software for executing functions of the deep state-space autoencoder 200. The modules 204a-204n, 208, 216a-216n, 220 may include further modules, such as pre-convolution modules 240, state-space model (SSM) modules 242, normalization modules 244, and linear unit modules 246, also configured as the hardware or software for executing functions of the modules 204a-204n, 208, 216a-216n, 220.

In some embodiments, the encoder modules 204a-204n and the decoder modules 216a-216n within the deep state-space autoencoder 200a-200d may dynamically adapt channel sizes at each layer based on the shape of the input tensor. For example, the channel count may begin as one and progressively increase to four, eight, or more channels, depending on the configuration of the respective layer. This dynamic adaptation may reduce computational overhead by aligning resource usage with the complexity of features at each layer. In addition, optimizing the sequence of operations within each layer, referred to as operational optimization, may further enhance computational efficiency. Such flexibility may distinguish these embodiments from fixed-channel architectures, which may lack the ability to efficiently balance resource utilization and computational demands.

The deep state-space autoencoders 200a-200d may belong to a class of temporal neural networks (TENNs) configured for real-time denoising of raw speech waveforms. By incorporating state-space models (SSMs), the deep state-space autoencoders 200a-200d may capture long-range temporal relationships within speech signals using stable linear recurrent units. These long-range correlations may allow the autoencoders 200a-200d to model global speech patterns, identify noise profiles, and implicitly capture semantic contexts that contribute to enhanced speech quality.

The architecture of the deep state-space autoencoders 200a-200d may include an hourglass structure with long-range skip connections. This configuration may down-sample audio data during encoding and up-sample it during decoding, which may preserve important details while reducing data dimensionality. The autoencoders 200a-200d may process raw audio waveforms directly to accommodate input signals in their full amplitude range, such as −1 to +1, and generate raw audio waveforms as output. This direct processing approach may eliminate the need for one-hot encoding or spectral domain transformations (e.g., short-time Fourier transform (STFT) or inverse STFT (iSTFT)), which are commonly used in conventional online speech enhancement systems. The autoencoders 200a-200d may similarly process audio waveforms transformed to a frequency domain.

For real-time inference, the deep state-space autoencoders 200a-200d may prioritize causality by avoiding bidirectional state-space layers. This design choice may reduce or minimize processing delays and ensure the autoencoders 200a-200d performs efficiently in scenarios requiring immediate speech enhancement.

Raw audio data, such as speech signals, may be sampled to generate an input signal sample 202 for the deep state-space autoencoders 200a-200d. The input signal sample 202 may represent the raw audio data in different forms, depending on the application. For example, in some embodiments, the input signal sample 202 may include a full-resolution sample capturing the original fidelity of the audio data at a specific time. Alternatively, the input signal sample 202 may be a compressed version of the raw audio data that includes reduced resolution or bit depth while retaining essential information for processing. The input signal sample 202 may also be a frequency domain transformation of the raw audio data.

The encoder modules 204a-204n may encode audio data using one or more neural networks that include hidden layers. These hidden layers may generate latent outputs 224a-224n for each encoder module 204a-204n. The number of encoder modules 204a-204n, represented as “n,” may be any positive integer greater than 1, such as 2 or 6.

As shown in FIG. 2E and described in more detail herein, the encoder modules 204a-204n may include components such as a pre-convolution module 240, a state-space model (SSM) module 242, a normalization module 244, and a linear unit module 246. These components may be combined in different ways to implement the neural networks within the encoder modules 204a-204n.

The first encoder module 204a may receive the input signal sample 202 and produce a corresponding latent output 224a. Later encoder modules 204b-204n may process outputs from earlier modules to create progressively refined representations of the audio data. This process may generate a sequence of latent outputs 224a-224n for use in subsequent stages.

With reference to FIGS. 2A and 2C, down-sample modules 206a-206n may be configured to reduce the temporal resolution of latent outputs 224a-224n generated by the encoder modules 204a-204n. These modules 206a-206n may produce corresponding down-sample outputs 226a-226n. The number of down-sample modules 206a-206n, denoted as “n,” may match the number of encoder modules 204a-204n.

The down-sample modules 206a-206n may perform operations that reduce the temporal dimension of the audio data while adjusting the channel dimension. This process involves reshaping the input data and then projecting it into a reduced dimensional space. More formally, for a reshaping ratio r and output channels L, a sequence of input features Cᵢₙ may be down-sampled and generate a sequence of output features Cₒᵤₜ as follows:

$$Down - s ample : ( {C}_{i n} , L ) {\to }^{reshape} ( {C}_{i n} r , L / r ) {\to }^{project} ( {C}_{out} , L / r )$$

This process ensures efficient compression of the input features while maintaining relevant information for subsequent processing stages.

Subsequent encoder modules 204a-204n may receive the down-sample outputs 226a-226n and process them through one or more neural networks that include hidden layers. These neural networks may produce latent outputs 224a-224n, which may correspond to each encoder module 204a-204n.

The final encoder module 204n may generate a latent output 224n, which may then be processed by the final down-sample module 206n. The final down-sample module 206n may reduce the temporal resolution of the latent output 224n, producing a final down-sample output 226n. This output 226n may then be forwarded to the bottleneck modules 208 for further processing.

The input signal sample 202 or the latent output 224a of the encoder module 204 and subsequent outputs, such as the latent outputs 224n and/or down-sample outputs 226a, may be progressively down-sampled and encoded as inputs to the subsequent down-sample modules 206a-206n and/or the subsequent encoder modules 204n.

The bottleneck modules 208 may be configured to process audio data through one or more neural networks that include hidden layers. These neural networks may produce latent outputs specific to the bottleneck modules 208. There may be at least two bottleneck modules 208 in the system.

For example, as illustrated in FIG. 2F and described in more detail herein, the bottleneck modules 208 may include various components, such as a state-space model (SSM) module 242, a normalization module 244, and a linear unit module 246. These components may work together to implement the neural networks within the bottleneck modules 208.

The bottleneck modules 208 may receive the final down-sample output 226n and process it to generate a bottleneck signal 210. For example, the first bottleneck module 208 may take the final down-sample output 226n as input, process it, and generate a latent output. This latent output may then be passed to a second bottleneck module 208, which may further process the data to produce the bottleneck signal 210. The bottleneck signal 210 may then be sent to the up-sample module 212a for subsequent processing.

With reference to FIGS. 2B and 2D, the functions of the down-sample modules 206a-206n may be integrated into and performed by the encoder modules 204a-204n. Each of the encoder modules 204a-204n may be configured to execute down-sampling of the latent outputs 224a-224n generated by the previous encoder modules 204a-204n as would the corresponding down-sample modules 206a-206n illustrated in FIGS. 2A and 2C. For example, machine learning models executed as part of the encoder modules 204a-204n, such as an SSM executed by an SSM module 242, may be trained and configured to execute down-sampling of the latent outputs 224a-224n generated by the previous encoder modules 204a-204n. The final encoder module 204n may generate the latent output 224n, which may then be forwarded to the bottleneck modules 208 for further processing. The bottleneck modules 208 may process the latent output 224n in a similar manner to processing the final down-sample output 226n as described above with reference to FIGS. 2A and 2C.

With reference to FIGS. 2A and 2B, the up-sample modules 212a-212n may process the bottleneck signal 210 and the combined outputs 230a-230n from the combination modules 214a-214n to produce up-sample outputs 228a-228n. These modules 228a-228n may perform operations that restore the temporal resolution and adjust the channel dimensions of the processed data.

The number of up-sample modules 212a-212n, denoted as “n,” may correspond to the number of decoder modules 216a-216n. This alignment may help ensure that each up-sample module works in conjunction with a corresponding decoder module to support efficient and coordinated data reconstruction.

The up-sample modules 212a-212n may be configured to perform operations that expand the temporal dimension of the audio data and adjust the channel dimension to fit the desired structure. This process may include reshaping the input features and then projecting them into a new space with modified temporal and channel properties. More formally, for a reshaping ratio of r and output channels L, a sequence of input features Cᵢₙ may be up-sampled and generate a sequence of output features Cₒᵤₜ as follows:

$$Up - sample : ( {C}_{i n} , L ) {\to }^{reshape} ( {C}_{i n} / r , Lr ) {\to }^{project} ( {C}_{out} , Lr )$$

This operation may help ensure that the temporal resolution is increased proportionally to the reshaping ratio r, while the channel dimension is adjusted to maintain consistency with the desired output structure.

The combination modules 214a-214n may be configured to combine the latent outputs 224a-224n of the encoder modules 204a-204n and the up-sample outputs 228a-228n to generate the combined outputs 230a-230n of the combination modules 214a-214n. The latent outputs 224a-224n and the up-sample outputs 228a-228n provided to the combination modules 214a-214n may share the same reshaping ratio (or “resampling factor”). In other words, these outputs 224a-224n, 228a-228n may have undergone equivalent levels of down-sampling and up-sampling to ensure compatibility. The combination modules 214a-214n may use operations such as addition or similar techniques to merge the data from the latent outputs and up-sample outputs effectively.

The decoder modules 216a-216n may be configured to decode audio data using one or more neural networks having one or more hidden layers generating latent outputs 232a-232n of the decoder modules 216a-216n and a final decoded signal 218. A number of decoder modules 216a-216n, represented as “n,” may be any positive integer greater than 1, including for example, 2 or 6, the same as the number of encoder modules 204a-204n.

For example, as illustrated in FIG. 2G and described in more detail herein, the decoder modules 216a-216n may incorporate components such as a pre-convolution module 240, a state-space model (SSM) module 242, a normalization module 244, and a linear unit module 246. These components may be configured to implement the functionality of the neural networks within the decoder modules 216a-216n.

The first decoder module 216a may receive the bottleneck signal 210 from the bottleneck modules 208 and process it to produce a corresponding latent output 232a. Subsequent decoder modules 216a-216n may receive the combined outputs 230a-230n and process them through one or more neural networks that include hidden layers. These hidden layers may generate latent outputs 232a-232n, which may correspond to each decoder module 216a-216n. A final decoder module 216n may generate a final latent output 232n referred to as a final decoded signal 218 to and send it to the output modules 220. In some embodiments, the output modules 220 may collectively form, or be referred to as, a postprocessing layer configured to refine the final decoded signal 218 to generate the enhanced output signal 222.

With reference to FIGS. 2C and 2D, the combination modules 214a-214n may be configured to combine the latent outputs 224a-224n of the encoder modules 204a-204n and the bottleneck signal 210 or the latent outputs 232a-232n to generate the combined outputs 230a-230n of the combination modules 214a-214n. The latent outputs 224a-224n and the bottleneck signal 210 or the latent outputs 232a-232n provided to the combination modules 214a-214n may share the same reshaping ratio. In other words, these outputs 224a-224n, 210, 232a-232n may have undergone equivalent levels of down-sampling and up-sampling to ensure compatibility. The combination modules 214a-214n may use operations such as addition or similar techniques to merge the data from the latent outputs and up-sample outputs effectively.

The functions of the up-sample modules 212a-212n may be integrated into and performed by the decoder modules 216a-216n. Each of the decoder modules 216a-216n may be configured to execute up-sampling of the combined outputs 230a-230n generated by the combination modules 214a-214n as would the corresponding up-sample modules 212a-212n illustrated in FIGS. 2A and 2B. For example, machine learning models executed as part of the decoder modules 216a-216n, such as an SSM executed by an SSM module 242, may be trained and configured to execute up-sampling of the combined outputs 230a-230n generated by the combination modules 214a-214n. The final decoder module 216n may generate the final decoded signal 218, which may then be forwarded to the output modules 220 for further processing.

The bottleneck signal sample 210 and subsequent outputs, such as the latent outputs 232a, up-sample outputs 228a-228n, and/or combined outputs 230a-230n, may be progressively up-sampled, combined, and encoded as inputs to the subsequent up-sample modules 212a-212n, the subsequent combination modules 214a-214n, and/or the subsequent decoder modules 216a-216n.

With reference to FIGS. 2A-2D, the output modules 220 may be configured to process audio data through one or more neural networks composed of hidden layers. These networks may generate latent outputs specific to the output modules 220. The system may include at least two output modules 220.

For example, as illustrated in FIG. 2H and described in more detail herein, the output modules 220 may incorporate components such as a state-space model (SSM) module 242, a normalization module 244, and a linear unit module 246. These components may work together to implement the functionality of the neural networks within the output modules 220.

The output modules 220 may receive the final decoded signal 218 and process it to produce an enhanced output signal 222. For example, the first output module 220 may take the final decoded signal 218 as input, process it, and produce a latent output. A subsequent output module 220 may receive the latent output from the first output module 220, refine it further, and generate the enhanced output signal 222. This enhanced signal may then be provided to an application executed by a processor 120-132. The enhanced output signal 222 may be a representation of the input signal sample 202 that is a denoised signal, a super-resolution signal, and/or a dequantized signal.

In some embodiments, the multiple encoder modules 204a-204n, bottleneck modules 208, decoder modules 216a-216n, and output modules 220 may be instances of execution of a single encoder module, bottleneck module, decoder modules, and output module executed by the processing system. For example, an encoder module may be executed multiple times, such as n times. In some embodiments, the multiple encoder modules 204a-204n, bottleneck modules 208, decoder modules 216a-216n, and output modules 220 may be individual modules executed by the processing system. For example, multiple encoder modules, such as n encoder modules, may be executed individually. The processing system may execute any combination of the encoder modules 204a-204n, bottleneck modules 208, decoder modules 216a-216n, and output modules 220 in parallel. For example, the processing system may execute any of the modules 204a-204n, 208, 216a-216n, and 220 to process an initial input signal sample 202. In parallel, the processing system may execute any of the modules 204a-204n, 208, 216a-216n, and 220 to process a subsequent input signal sample 202 while processing the initial input signal sample 202.

With reference to FIGS. 2E-2H, the encoder modules 204a-204n, bottleneck modules 208, decoder modules 216a-216n, and output modules 220 may process audio data using one or more neural networks having one or more hidden layers. For example, the neural networks may include any combination of a pre-convolution module 240, an SSM module 242, a normalization module 244, and a linear unit module 246 configured to implement the neural networks. In some embodiments, configurations of the neural networks of the modules 204a-204n, 208, 216a-216n, 220 may differ based on use, including training and inference.

The pre-convolution module 240 may be configured to prepare or transform an input into any of the modules 204a-204n, 208, 216a-216n, 220 for processing by the subsequent neural networks or layers, such as executed by any combination of the SSM module 242, the normalization module 244, and the linear unit module 246. The pre-convolution module 240 may execute a convolution layer to facilitate processing of local temporal features. For example, the pre-convolution module 240 may execute a depthwise 1D convolution layer with a kernel size of 3. In some embodiments, using causal convolutions for the pre-convolution module 240 may eliminate additional latencies to the deep state-space autoencoders 200a-200d. In some embodiments, the pre-convolution module may use an infinite kernel window to enhance the temporal resolution of local features, particularly in configurations with state-space model layers. These embodiments may better support efficient processing of long-range dependencies without incurring additional latency.

In some embodiments, the pre-convolution module 240 may be omitted from or not implemented by the bottleneck modules 208 and in any of the modules 204a-204n, 216a-216n, 220 with only one channel. The bottleneck modules 208 may operate on fully down-sampled features, and introducing pre-convolution may incur latency in real-time processing. In single-channel modules, pre-convolution may be lossy.

In some embodiments, the pre-convolution module 240 may be implemented in any, including all, of the encoder modules 204a-204n and omitted from or not implemented by all of the other modules 208, 216a-216n, 220. In some embodiments, the pre-convolution module 240 may be omitted from or not implemented by all of the modules 204a-204n, 208, 216a-216n, 220. Omitting or not implementing the pre-convolution module 240 may reduce processing and memory resource usage and power consumption by the SoC 100. The reduction in computing and power resource consumption may be advantageous for computing devices, particularly for computing devices with restricted computing and power resources, such as mobile computing devices.

For embodiments that include the pre-convolution module 240, a pre-convolution output 248 of the pre-convolution module 240 may be provided to the SSM module 242. For embodiments, without the pre-convolution module 240 an input into any of the modules 204a-204n, 208, 216a-216n, 220 may be provided to the SSM module 242. The SSM module 242 may execute an SSM for the received input and be configured to capture long-range temporal relationships present in speech signals.

SSMs may be representations of linear time-invariant (LTI) systems, and they may be uniquely specified by four matrices: A∈ [symbol] ^{h×h}, B∈ [symbol] ^{h×p}, C∈ [symbol] ^{m×h}, and D∈ [symbol] ^{m×p}. Each matrix may include a set of the real values of internal states h, inputs p, and outputs m. A first-order ordinary differential equation describing the LTI system may be given as:

$$\dot{x} = Ax + B u , y = C x + D u$$

where u∈ [symbol] ^{p} may be an input signal, x∈ [symbol] ^{h} may be an internal state, and y∈ [symbol] ^{m} may be an output. In some embodiments, p>1, m>1, which may yield a multiple-input, multiple-output (MIMO) SSM. In some embodiments, Du may not be used and may be ignored.

The SSM in its original form may describe a continuous-time system, but in the field of digital signal processing, there are standard processes for discretizing such a system into a discrete-time SSM. One example that may be used is the zero-order hold (ZOH), which may give the discrete-time state-space matrices Ā and B̅ as follows:

$$\overline{A} = exp ( Δ A ) , \overline{B} = {( Δ A )}^{- 1} \cdot ( exp ( Δ A ) - 1 ) \cdot Δ B$$

The discrete state-space model is then given by:

$$x [ t + 1 ] = \overline{A} x [ t ] + \overline{B} u [ t ] , y [ t ] = C x [ t ]$$

for a time t. In the context of RNNs, this is essentially a linear RNN layer, which may allow for efficient online inference and generation, such as for real-time speech enhancement and efficient parallelization during training.

One may check that the discrete-time impulse response is given as:

$$k [ t ] = C {\overline{A}}^{τ} \overline{B}$$

where τ may denote a kernel timestep. During training, k may be considered a “full” long 1D convolutional kernel with shape (output channels, input channels, length), in the sense that the output y may be computed via the long convolution:

$${y}_{j} = {\sum }_{i} {u}_{i} * {k}_{i j}$$

By the convolution theorem, this operation may be performed in the frequency domain, which becomes a point-wise product:

$${\hat{y}}_{j f} = {\sum }_{i} {u}_{i} {\hat{k}}_{i j f}$$

The hat symbol may denote the Fourier transform of the signal (with the index f denoting the Fourier modes), which may be efficiently computed via Fast Fourier Transforms (FFTs).

A diagonal form may exist for the SSM, meaning that it may approximately always be assumed that Ā may be diagonal, at the expense of B̅ and C̅ potentially being complex matrices. For example, allowing B̅ and C̅ to be complex matrices, it may be assumed for Ā to be diagonal without any loss of generality. Allowing Ã=P⁻¹Λ_{A}P (where Λ_{A} may be the diagonalized Ā matrix, and P may be the similarity matrix) the following may occur:

$$\begin{matrix}\begin{matrix}∀ t , & k [ t ] = {C ( {P}^{- 1} {Λ}_{A} P )}^{t - 1} \overline{B}\end{matrix} \\ = C {P}^{- 1} {\underbrace{{Λ}_{A} ( P {P}^{- 1} ) … {Λ}_{A} ( P {P}^{- 1} )}}_{repeat t - 1 times} P \overline{B} \\ = ( C {P}^{- 1} ) {Λ}_{A}^{t - 1} ( P \overline{B} ) \\ = {C}^{′} {Λ}_{A}^{t - 1} {\overline{B}}^{′}\end{matrix}$$

where B̅′ and C̅′ may be complex matrices that have “absorbed” the similarity matrix P. Without any loss of generality, B̅′ and C̅′ may be redefined to be B̅ and C̅. Since Ã is a real matrix, the complex eigenvalues in Λ_{A} may come in conjugate pairs. And without any loss of generality, Λ_{A} may be redefined as Ā.

Since the original system may be a real system, the diagonal Ā matrix may contain only real elements and/or complex elements in conjugate pairs. Restricting B̅ and C̅ to be real matrices and letting Ã be a diagonal matrix with all complex elements (but not restricting them to come in conjugate pairs) may result in a slight loss in expressivity. In some embodiments, to work with real features, the real part of the impulse response kernel may be expressed as:

$$k [ t ] = ( C {\overline{A}}^{τ} \overline{B} )$$

which equivalently in the state-space equation may be achieved by letting:

$$y [ t ] = C ( x [ t ] )$$

As such, during online inference, the internal states x may be maintained as complex values, and the real parts may be propagated to the next layer.

The parameters {A, B, C, Δ} to be directly learnable, which may indirectly train the kernel k. Additionally, sizes of p, h, and may not be restricted to be consistent, which may allow for more flexibility in feature extraction at each layer, mirroring the flexibility in selecting channel and kernel sizes in convolutional neural networks. The size of the internal state h may be interpreted as a degree of parametrization of a basis temporal kernel or some implicit (dilated) “kernel size” in the frequency domain. The flexibility of the tensor shapes may control choosing an order of operations during training to minimize a computational load.

During training of the deep state-space autoencoders 200a-200d, infinite impulse response (IIR) kernels of the SSM layers may be used as long convolutional kernels over the input features, which may be parallelized using techniques such as FFT convolution or associative scan. During inference, temporal convolution layers may be converted into equivalent recurrent layers for efficient real-time processing on mobile devices, minimizing latency and reducing the need for excessive buffering of data.

In some embodiments, for initialization of parameters of the SSM for stability, for A∈C^{h}, a complex vector (or a complex diagonal matrix), the real and complex parts of A may be treated separately. The real part [symbol] (A) may be parameterized as −softplus (aᵣ), where, for example, aᵣ may be initialized with a value −0.4328, giving [symbol] (A)=−½ initially. Due to positivity of softplus, [symbol] (A) may remain negative during training, which may ensure stability of the SSM layer. The imaginary part [symbol] (a) may be parameterized directly and initialized with π(i−1) where i is a state index. The matrix B∈ [symbol] ^{h×p} may be initialized with all ones, and the matrix C∈ [symbol] ^{m×h} may be initialized with Kaiming normal random variables (assuming a fan in of h). Δ may be initialized with 0.001×100^{└i/16┘}, giving a series of geometrically spaced values from 0.001 to 0.1 in blocks of 16. These initializations and parameterizations may vary, and other approaches respecting the stability of the SSM layer may achieve similar results.

In some embodiments, a contraction order of the SSM may be based on K(t)=Ā^{t} being configured as “basis kernels” of the SSM layer, and its Fourier transform being \hat{K}(f). In einsum form, the SSM layer operations during training may be expressed as:

$${\hat{y}}_{bjf} = {\hat{x}}_{bjf} {\overline{B}}_{v i} {\hat{K}}_{v f} {C}_{j v}$$

where {b, i, j, v, f} indexes a batch size, input channels, output channels, internal states, and Fourier modes respectively. With abuse of notation, {B, I, J, N, F} may be sizes of the five dimensions. A number of Fourier modes F may be the same as the length of the signal L (or approximately half of L for real FFT).

There may be alternative ways to compute y. In some embodiments, the operations of the above einsum form of the SSM layer operations may be executed from left to right, corresponding to projecting the input to the SSM, performing the FFT convolution, and projecting the output of the SSM. In some embodiments, the full kernel may be calculated and the full FFT convolution with the input as \hat{x}_{bif}(B̅ₙᵢ\hat{K}_{nf}Cⱼₙ) may be performed. Focusing on the computational requirements of the forward pass, the first contraction order may result in BNIF+BNF+BJNF≈BNF(I+J) units of computation. The second contraction order may result in JNI+JNIF+BJIF≈JIF(B+N) units of computation. The contraction order may be intimately linked with the dimensions of the tensor operands. More formally, BNF(I+J)<JIF(B+N) or

$$\frac{1}{B} + \frac{1}{N} > \frac{1}{I} + \frac{1}{J}$$

may be advantageous for the first order of contraction.

For some embodiments in which the deep state-space autoencoders 200b, 200d exclude down-sample modules 206a-206n configured to down-sample the latent outputs 224a-224n, the SSM may be trained and configured to execute down-sampling based on the latent outputs 224a-224n input to the encoder modules 204a-204n. For example, the SSM may be implemented using weights and parameters that are configured so that features generated by the SSM based on the latent outputs 224a-224n, directly or based on the pre-convolution output 248, reflect down-sampling of the input latent outputs 224a-224n. In other words, the features generated by the SSM based on the latent outputs 224a-224n, directly or based on the pre-convolution output 248, may be at least approximately the same as features generated by the SSM based on down-sample outputs 226a-226n, directly or based on the pre-convolution output 248.

For some embodiments in which the deep state-space autoencoders 200c, 200d exclude up-sample modules 212a-212n configured to up-sample the bottleneck signal 210 or the latent outputs 232a-232n, the SSM may be trained and configured to execute up-sampling based on the combined outputs 230a-230n input to the decoder modules 216a-216n. For example, the SSM may be implemented using weights and parameters that are configured so that features generated by the SSM based on the combined outputs 230a-230n, directly or based on the pre-convolution output 248, reflect up-sampling of the input combined outputs 230a-230n. In other words, the features generated by the SSM based on the combined outputs 230a-230n, directly or based on the pre-convolution output 248, may be at least approximately the same as features generated by the SSM based on up-sample outputs 228a-228n via the combined outputs 230a-230n.

Weights and parameters of the SSM may be trained to enable the SSM to implement various inference functions for various inputs. In some embodiments, the inference functions may include one or more of denoising, super-resolution, and de-quantization of audio signals.

For embodiments that include the normalization module 244, an SSM output 250 of the SSM module 242 may be provided to the normalization module 244. For embodiments, without the normalization module 244, the SSM output 250 of the SSM module 242 may be provided to the linear unit module 246.

The normalization module 244 may be configured to adjust the activations of the layers within the deep state-space autoencoders 200a-200d. This adjustment may reduce variations in the loss profile or parameter surface, contributing to more stable and efficient training or inference. The execution of the normalization module 244 may depend on the type of normalization applied. It may operate during the training phase, the inference phase, or both, based on the requirements of the specific embodiment. In embodiments in which the normalization module 244 is executed, it may produce a normalization output 252. This output may be forwarded to the linear unit module 246 for further processing.

In some embodiments, the normalization module 244 may be configured to implement layer normalization, which may be implemented in training of the deep state-space autoencoders 200a-200d and during inference by the deep state-space autoencoders 200a-200d. Layer normalization may be implemented to avoid introducing new dependencies between training cases.

In some embodiments, the normalization module 244 may be configured to implement batch normalization, which may be implemented in training of the deep state-space autoencoders 200a-200d and/or during inference by the deep state-space autoencoders 200a-200d. Batch normalization is a static form of normalization during inference. The normalization statistics and the affine parameters may be incorporated into weights and biases of a previous layer, such as the SSM, during training of the deep state-space autoencoders 200a-200d. Accordingly, the normalization module 244 implementing batch normalization may not need to be materialized or executed during inference by the deep state-space autoencoders 200a-200d. Avoiding executing the normalization module 244 during inference by the deep state-space autoencoders 200a-200d may reduce processing and memory resource usage and power consumption by the SoC 100. The reduction in computing and power resource consumption may be advantageous for computing devices, particularly for computing devices with restricted computing and power resources, such as mobile computing devices.

The linear unit module 246 may be configured to implement linear transformation of the inputs to the linear unit module 246. In some embodiments, the inputs to the linear unit module 246 may include the normalization output 252. In some embodiments, the inputs to the linear unit module 246 may include the SSM output 250. In some embodiments, the linear unit module 246 may be a SiLU configured to apply a sigmoid function to the outputs of the layers of the linear unit module 246. In some embodiments, the linear unit module 246 may be a ReLU configured to apply a rectification function to the outputs of the layers of the linear unit module 246. The linear unit module 246 as a ReLU and the normalization module 244, which may implement batch normalization, may both be implemented in some embodiments. The linear unit module 246 may generate the latent outputs 224a-224n.

The following descriptions discuss non-limiting experimental results of multiple embodiments of the deep state-space autoencoders 200a-200d to illustrate exemplary benefits of the deep state-space autoencoders 200a-200d as compared to some non-limiting examples of other deep neural networks used for real-time audio denoising. The exemplary benefits are illustrated in terms of performance, memory/computational requirements, and latency. Unless stated otherwise, the experiments were conducted using a configuration of the deep state-space autoencoder 200a that included the pre-convolution module 240 in all modules (204a-204n, 208, 216a-216n, and 220), the normalization module 244 with layer normalization, and the linear unit module 246 implemented as a SiLU.

During the experiments, the deep state-space autoencoder 200a was trained on the VCTK and LibroVox datasets from the Microsoft DNS Challenge. Noise samples from Audioset, Freesound, and DEMAND were mixed randomly with the clean samples. The denoising performance of the decoded signal, referred to as the enhanced output signal 222, was evaluated using the Voicebank+DEMAND (VB-DMD) test set and the Microsoft DNS1 synthetic test set without reverberation. To prevent data leakage, clean and noise samples used for generating synthetic test samples were excluded from the training sets. Both input and output signals were standardized at a sampling rate of 16,000 Hz. The loss function combined SmoothL1Loss and spectral loss measured at the ERB scale.

The deep state-space autoencoder 200a was trained for 500 epochs using the AdamW optimizer with a learning rate of 0.005 and a weight decay of 0.02. Training included a cosine decay scheduler with a linear warmup set to 1% of the total training steps. Each epoch utilized the entire VCTK training set and a random subset of the LibroVox training set, including 10% of its samples. Random noisy samples were synthesized during training by mixing clean samples with noise at signal-to-noise ratios (SNR) uniformly distributed between −5 dB and 15 dB.

The evaluation metric used for performance was the average wideband perceptual evaluation of speech quality (PESQ) score, which measured the similarity between the clean signals and the denoised outputs. Latency was assessed based on theoretical maximum time the autoencoder may “look ahead” to produce a denoised output for the current input, excluding any processing overhead. Unless noted otherwise, the evaluation utilized the source code and pre-trained weights for each model, tested through a standardized PESQ evaluation pipeline. The PESQ scores and additional metrics, such as parameters, multiply-accumulate operations (MACs), and latency, for various configurations of the deep state-space autoencoder 200a and other real-time audio-denoising networks, are summarized in the table below:

| | PESQ | PESQ | | | | |
|---|---|---|---|---|---|---|
| | (VB- | (DNS1 | | MACs/ | | |
| Model | DMD) | no-reverb) | Parameters | sec | Latency | |
| DeepFilterNet3 | 3.16 | 2.58 | 2.13M | 0.344G | 40 | ms |
| DEMUCS | 2.56 | 2.65 | 33.53Ma | 7.72Ga | 40 | ms |
| PercepNet | 2.73b | — | 8.00M | 0.80G | 40 | ms |
| RNNoise | 2.43 | 1.94 | 0.06M | 0.04G | 20 | ms |
| Deep state-space autoencoder | 3.27 | 2.98 | 0.84M | 0.33G | 46.5 | ms |
| 200a | | | | | | |
| Pre-convolution module 240 | 3.21 | 2.84 | 0.84M | 0.33G | 31.25 | ms |
| only in encoder modules 204a- | | | | | | |
| 204n | | | | | | |
| No Pre-convolution module 240 | 3.06 | 2.59 | 0.84M | 0.33G | 16 | ms |
| No Pre-convolution module | 2.84 | 2.43 | 0.84M | 0.33G | 16 | ms |

240, normalization module 244
implementing batch
normalization and linear unit
module 246 as a ReLU

In the above table, the parameters and MACs/sec values for DEMUCS were estimated by passing a one-second segment of data to the DEMUCS model. Also, The PESQ (VB-DMD) value for PercepNet were sourced from directly from Valin et al., “A perceptually-motivated approach for low-complexity, real-time enhancement of fullband speech,” arXiv preprint arXiv:2008.04259, 2020.

Experimental results for other common speech-enhancement metrics for the deep state-space autoencoder 200a are illustrated in the following table:

| Testset | PESQ | CSIG | CBAK | COVL | SI-SDR |
|---|---|---|---|---|---|
| VB-DMD | 3.27 | 4.57 | 2.85 | 3.96 | 15.04 |
| DNS1 | 2.98 | 4.28 | 3.55 | 3.57 | 15.40 |

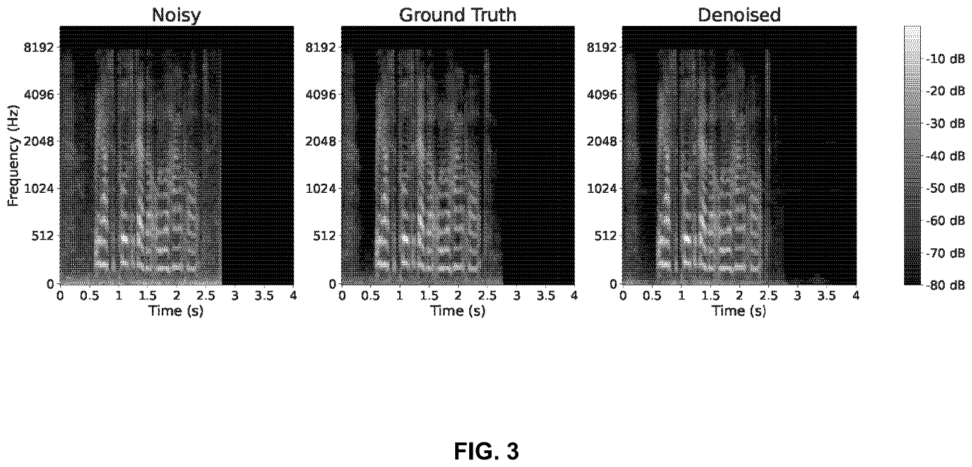

For further inspection of the quality of the denoised samples produced by the deep state-space autoencoder 200a, spectrograms of the noisy, the clean or ground truth, and the denoised audio samples of the DNS1 synthetic testset (no reverb) are illustrated in FIG. 3. Comparison of the spectrograms illustrates that the denoised samples do not contain any unnatural artifacts that are common with raw audio processing systems, which may not be captured by the PESQ score. Besides a minor low-frequency artifact in the silent region, the denoised output matches very close to the ground truth signal, despite not using any pre/post-processing in the spectral domain.

In some embodiments, the deep state-space autoencoders 200a-200d may be implemented to perform super-resolution and de-quantization on compressed data. In some embodiments, the input signals to the deep state-space autoencoders 200a-200d may be down-sampled and quantized, in that order, and the deep state-space autoencoders 200a-200d may be trained to handle the degraded/compressed inputs. In some embodiments, to restore the original sample rate of down-sampled audios, the deep state-space autoencoders 200a-200d may execute interleaved repeats of the input signals. In some embodiments, to restore the original sample rate of down-sampled audios, the deep state-space autoencoders 200a-200d may be executed omitting an encoder module 204a-204n with the same down-sampling factor as the down-sampled input. Mu-law encoding may be implemented to quantize the input signals down to a specified bitwidth and the deep state-space autoencoders 200a-200d may rescale the quantized signal back to the −1 to +1 range. Experimental results of implementing the deep state-space autoencoder 200a to perform super-resolution and de-quantization evaluated against clean signals at 16000 Hz and full precision are illustrated in the following table.

| Input Type | VoiceBank | DNS1 |
|---|---|---|
| 8000 Hz & 8 bit | 3.19 | 2.88 |
| 4000 Hz & 8 bit | 3.04 | 2.72 |
| 8000 Hz & 4 bit | 2.90 | 2.55 |
| 4000 Hz & 4 bit | 2.72 | 2.39 |

In some embodiments, to perform super-resolution and de-quantization on compressed data, parameter-efficient fine-tuning of the deep state-space autoencoders 200a-200d, such as using low-rank adaptations on the state-space matrices, may configure the deep state-space autoencoders 200a-200d handle the degraded/compressed inputs.

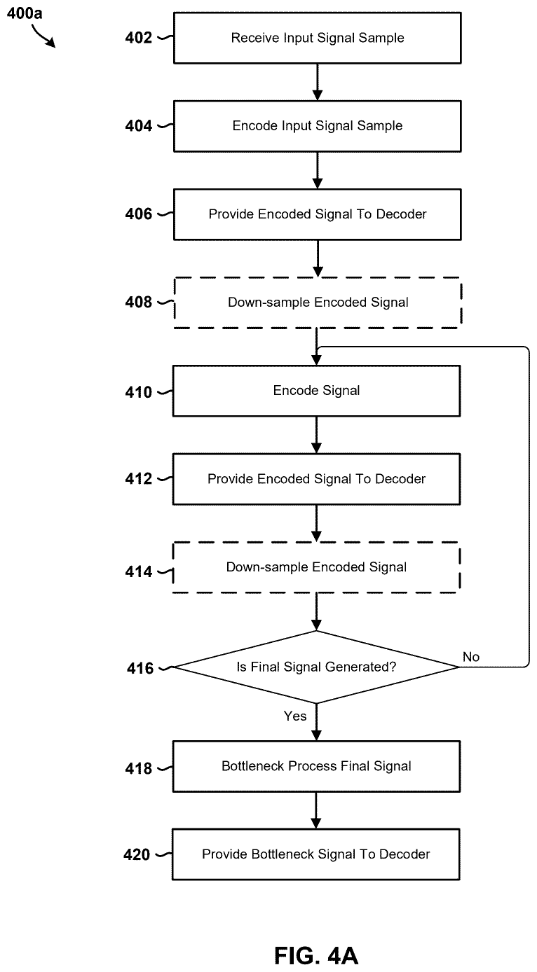

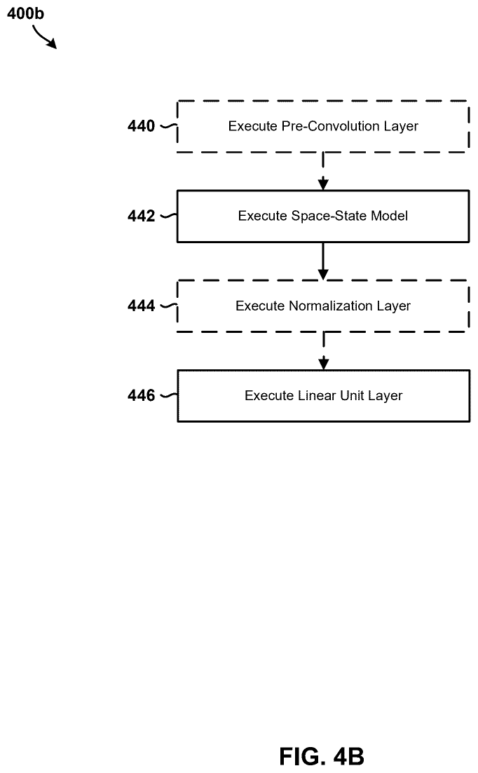

FIGS. 4A and 4B are process flow diagrams illustrating example flows/methods 400a, 400b for implementing a deep state-space autoencoder configured for efficient online audio enhancement in accordance with some embodiments. Methods 400a, 400b may be performed in a computing device by a processing system encompassing one or more processors (e.g., processors 120-132, etc.), components, or subsystems discussed in this application. The processing system may execute processing system-executable instructions (e.g., modules 204a-204n, 208, 216a-216n, 220) stored on a non-transitory processor-readable medium (e.g., memory 136).

For the method 400a, with reference to FIG. 4A, in block 402, the processing system may receive an input signal sample 202. In some embodiments, the input signal sample 202 may represent raw audio data at full resolution for a specific time frame. In some embodiments, the input signal sample 202 may be a compressed version of the raw audio data. In some embodiments, the input signal sample 202 may be a frequency domain transformation of the raw audio data. A deep state-space autoencoder 200a-200d, including the encoder module 204a, may receive the input signal sample 202. In some embodiments, the pre-convolution module 240 within the encoder module 204a may receive the input signal sample 202. In some embodiments, the state-space model (SSM) module 242 within the encoder module 204a may receive the input signal sample 202. In some embodiments, receiving the input signal sample 202 may include the processing system executing specific functions of the encoder module 204a.

In block 404, the processing system may encode the input signal sample 202. In some embodiments, encoding the input signal sample 202 may include the processing system executing functions of the encoder module 204a, which may include any combination of the pre-convolution module 240, the SSM module 242, the normalization module 244, and the linear unit module 246. In some embodiments, the encoding operations may generate an encoded signal as a latent output 224a. In some embodiments, the encoded signal may represent a transformed version of the input signal sample 202. The encoding process is described further for method 400b with reference to FIG. 4B.

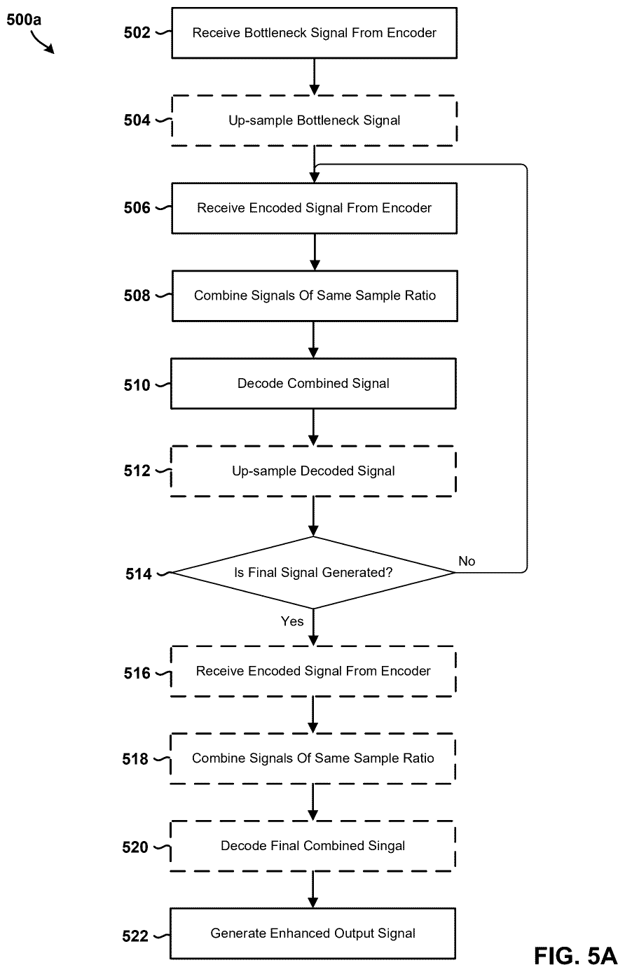

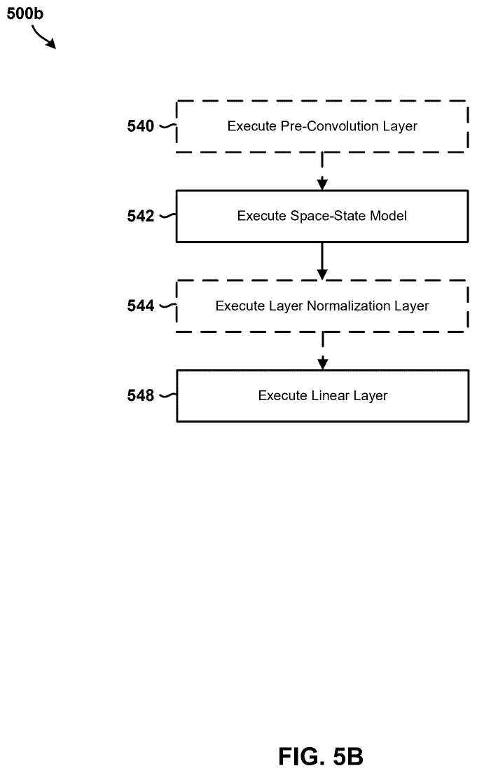

In block 406, the processing system may provide the encoded signal to a decoder. In some embodiments, the combination module 214n of the decoder within the deep state-space autoencoder 200a-200d may receive the encoded signal. In some embodiments, providing the encoded signal to the decoder may include the processing system executing functions of the encoder module 204a. Additional details regarding the processing of the encoded signal by the decoder are discussed in methods 500a and 500b with reference to FIGS. 5A and 5B.

In optional block 408, the processing system may down-sample the encoded signal. Down-sampling the encoded signal may include the processing system executing functions of the down-sample module 206a of the deep state-space autoencoder 200a, 200c. The down-sampling operations may reduce (or squeeze) the temporal dimension of the encoded signal while projecting its channel dimension to generate a down-sample signal. In some embodiments, the down-sample signal may correspond to a down-sample output 226a.

In block 410, the processing system may encode a signal. In embodiments executing optional block 408, the processing system may encode the down-sample signal. Encoding the down-sample signal may include the processing system executing functions of an encoder module 204a-204n, including functions of any combination of the modules 240, 242, 244, 246. An encoded signal may be generated by encoding the down-sample signal. In embodiments not executing optional block 408, the processing system may encode the previous encoded signal from a previous encoding. Encoding the previous encoded signal may include the processing system executing functions of an encoder module 204a-204n, including functions of any combination of the modules 240, 242, 244, 246, which may include down-sampling. An encoded signal may be generated by encoding the previous encoded signal. The encoded signal may be a latent output 224a-224n of the processing system executing functions of the encoder module 204a-204n. Encoding the down-sample signal is described further herein for the method 400b with reference to FIG. 4B.

In block 412, the processing system may provide the encoded signal to a decoder. The encoded signal may be provided to a combination module 214a-214n of the decoder of the deep state-space autoencoder 200a-200d. Processing of the encoded signal provided to the decoder is described further herein for the methods 500a, 500b with reference to FIGS. 5A and 5B. Providing the encoded signal to the decoder may include the processing system executing functions of the encoder module 204a-204n.

In optional block 414, the processing system may down-sample the encoded signal. Down-sampling the encoded signal may include the processing system executing functions of a down-sample module 206a-206n of the deep state-space autoencoder 200a, 200c. Down-sampling operations may reduce (or squeeze) the temporal dimension of the encoded signal while projecting its channel dimension to generate a down-sample signal. The down-sample signal may correspond to a down-sample output 226a-226n.

In determination block 416, the processing system may identify whether a final signal is generated. In embodiments executing optional blocks 408, 414, the processing system may identify whether a final down-sampling is complete. In embodiments not executing optional blocks 408, 414, the processing system may identify whether a final encoding is complete. In some embodiments, identifying generation of a final signal may involve the processing system tracking how many times or to which reshaping ratio r down-sampling has been implemented for the input signal sample 202 or the encoded signals derived, at least in part, from the input signal sample 202. In some embodiments, identifying generation of a final signal may involve the processing system tracking how many times encoding has been implemented for the input signal sample 202 or the encoded signals derived, at least in part, from the input signal sample 202. In some embodiments, identifying generation of a final signal may involve the processing system generating a final down-sample output 226n. In some embodiments, identifying generation of a final signal may involve the processing system generating a latent output 224n. Identification of whether a final signal is generated may be a process of the processing system executing functions of the final down-sample module 206n or the encoder module 204n.

In response to determining that the final signal is not generated (i.e., determination block 416=“No”), the processing system may encode the signal in block 410. In response to determining that the final signal is generated (i.e., determination block 416=“Yes”), the processing system may bottleneck process the final signal in block 418. The final signal may be a final down-sample output 226n of the processing system executing functions of the final down-sample module 206n in embodiments executing optional blocks 408, 414. The final signal may be a latent output 224n of the processing system executing functions of the encoder module 204n in embodiments not executing optional blocks 408, 414. Bottleneck processing the final signal may include the processing system executing functions of the bottleneck modules 208, including functions of any combination of the modules 242, 244, 246. A bottleneck signal 210 may be generated by bottleneck processing the final signal. The bottleneck signal 210 may be a latent output of the processing system executing functions of the bottleneck modules 208. Bottleneck processing the final signal is described further herein for the method 400b with reference to FIG. 4B.

In block 420, the processing system may provide the bottleneck signal 210 to the decoder. In some embodiments, bottleneck signal 210 may be provided to the up-sample module 212a of the decoder of the deep state-space autoencoder 200a, 200b. In some embodiments, bottleneck signal 210 may be provided to the combination module 214a of the decoder of the deep state-space autoencoder 200c, 200d. Processing of the bottleneck signal 210 provided to the decoder is described further herein for the methods 500a, 500b with reference to FIGS. 5A and 5B. Providing the bottleneck signal 210 to the decoder may include the processing system executing functions of the bottleneck modules 208.

For the method 400b, with reference to FIG. 4B, blocks 440-446 may further describe encoding the input signal sample 202 in block 404 and encoding the signal in block 410. Blocks 442-446 may further describe bottleneck processing the final signal in block 418.

In optional block 440, the processing system may execute one or more pre-convolution layers. A pre-convolution layer may be configured to prepare or transform an input into any of the modules 204a-204n, 208 for processing by the subsequent neural networks or layers. The pre-convolution layer may be configured to facilitate processing of local temporal features. For example, the pre-convolution layer may include a depthwise 1D convolution layer with a kernel size of 3. For another example, the pre-convolution layer may be executed using a finite window or infinite window convolution. In some embodiments, the pre-convolution layer may be executed based on an input of the input signal sample 202. In some embodiments, executing optional blocks 408, 414, the pre-convolution layer may be executed based on an input of the down-sample signal. In some embodiments, not executing optional blocks 408, 414, the pre-convolution layer may be executed based on an input of the previous encoded signal. Executing the pre-convolution layers may generate a pre-convolution output 248. Executing the pre-convolution layers may include the processing system executing functions of the pre-convolution module 240 of the encoder module 204a-204n.

In block 442, the processing system may execute an SSM. The SSM may be executed for a received input and be configured to capture long-range temporal relationships present in speech signals. In some embodiments, where the processing system executes the pre-convolution layers of the encoder module 204a-204n, the SSM may be executed based on an input of the pre-convolution output 248. In some embodiments, where the processing system does not execute the pre-convolution layers of or omitted from the encoder module 204a-204n, the SSM may be executed based on an input of the input signal sample 202 or another signal. In some embodiments executing optional blocks 408, 414, the input of the other signal may include an input of the down-sample signal. In some embodiments not executing optional blocks 408, 414, the input of the other signal may include an input of the previous encoded signal. In some embodiments not executing optional blocks 408, 414, the SSM of the encoder module 204a-204n may also be executed for the received input and be configured to execute down-sampling based on an input of the pre-convolution output 248 or the previous encoded signal. In some embodiments, where the processing system does not execute the pre-convolution layers of or omitted from the bottleneck modules 208, the SSM may be executed based on an input of the final signal. Executing the SSM layer may generate an SSM output 250. Executing the SSM layer may include the processing system executing functions of the SSM module 242 of the encoder module 204a-204n or the bottleneck modules 208.

In optional block 444, the processing system may execute one or more normalization layers. Executing the normalization layer may normalize activations of the layers of deep state-space autoencoder 200a-200d, smoothing a loss profile or surface of the parameters of the deep state-space autoencoder 200a-200d. In some embodiments, a normalization layer may be configured for layer normalization. Layer normalization may be implemented to avoid introducing new dependencies between training cases. In some embodiments, a normalization layer may be configured for batch normalization. The normalization layer configured for batch normalization may be executed during training of the deep state-space autoencoder 200a-200d and may be omitted during inference by the deep state-space autoencoder 200a-200d. The normalization layer may be executed based on an input of the SSM output 250. Executing the normalization layers may generate a normalization output 252. Executing the normalization layers may include the processing system executing functions of the normalization module 244 of the encoder module 204a-204n or the bottleneck modules 208.

In block 446, the processing system may execute one or more linear unit layers. Executing a linear unit layer may implement a linear transformation of the inputs to the linear layer. In some embodiments, a linear unit layer may be a SiLU configured to apply a sigmoid function. In some embodiments, a linear unit layer may be a ReLU configured to apply a rectification function. The linear unit layer as a ReLU may be implemented in embodiments also implementing the normalization layer implementing batch normalization. In some embodiments, where the processing system executes the normalization layers of the encoder module 204a-204n or the bottleneck module 208, the inputs to the linear layer may include the normalization output 252. In some embodiments, where the processing system does not execute the normalization layers of or omitted from the encoder module 204a-204n or the bottleneck module 208, the inputs to the linear unit module 246 may include the SSM output 250. Executing the linear unit layers may generate a latent output 224a-224n or a bottleneck signal 210. Executing the linear unit layers may include the processing system executing functions of the linear unit module 246 of the encoder module 204a-204n or the bottleneck modules 208.

FIGS. 5A and 5B are process flow diagrams illustrating example flows/methods 500a, 500b for implementing a deep state-space autoencoder configured for efficient online audio enhancement in accordance with some embodiments. Methods 500a, 500b may be performed in a computing device by a processing system encompassing one or more processors (e.g., processors 120-132, etc.), components, or subsystems discussed in this application. The processing system may execute processing system-executable instructions (e.g., modules 204a-204n, 208, 216a-216n, 220) stored on a non-transitory processor-readable medium (e.g., memory 136).

For the method 500a, with reference to FIG. 5A, in block 502, the processing system may receive a bottleneck signal 210 from the encoder of the deep state-space autoencoder 200a-200d. The bottleneck signal 210 may be received by the deep state-space autoencoder 200a-200d, including the up-sample module 212a, executed by the processing system. Receiving a bottleneck signal 210 from the encoder may include the processing system executing functions of the up-sample module 212a.

In optional block 504, the processing system may up-sample the bottleneck signal 210. Up-sampling the bottleneck may include the processing system executing functions of the up-sample module 212a of the deep state-space autoencoder 200a, 200b. Up-sampling operations may expand temporal dimension of the audio data and then project the channel dimension generating an up-sample signal. The up-sample signal may be the up-sample output 228a of the processing system executing functions of the up-sample module 212a.

In block 506, the processing system may receive an encoded signal from the encoder of the deep state-space autoencoder 200. The encoded signal may be a latent output 224a-224n of the processing system executing functions of the encoder module 204a-204n. The encoded signal may be received by the deep state-space autoencoder 200, including a combination module 214a-214n, executed by the processing system.

In block 508, the processing system may combine signal. In embodiments executing optional block 504, the processing system may combine the up-sample signal and the encoded signal. In embodiments not executing optional block 504, the processing system may combine the bottleneck signal 210 or a decoded signal, such as a latent output 232a-232n. and the encoded signal The signals combined by the processing system may include data of the same reshaping ratio. In other words, the processing system may combine the signals of the same degree of reshaping, or down-sampling and up-sampling. Combination of the signals may be accomplished through one or more operations, such as addition to generate a combined signal, which may be a combined output 230a-230n. Combining the signals may include the processing system executing functions of the combination module 214a-214n.

In block 510, the processing system may decode the combined signal. Decoding the combined signal may include the processing system executing functions of a decoder module 216a-216n, including functions of any combination of the modules 240, 242, 244, 246. In embodiments not executing optional block 504, the functions of the decoder module 216a-216n executed by the processing system may include up-sampling. A decoded signal may be generated by decoding the combined signal. The decoded signal may be a latent output 232a-232n of the processing system executing functions of the decoder module 216a-216n. In embodiments not executing optional block 504, the decoded signal may be the latent output 232n or the final decoded signal 218. Decoding the combined signal is described further herein for the method 500b with reference to FIG. 5B.

In optional block 512, the processing system may up-sample the decoded signal. Up-sampling the decoded may include the processing system executing functions of the up-sample module 212a-212n of the deep state-space autoencoder 200a, 200b. Up-sampling operations may expand temporal dimension of the audio data and then project the channel dimension generating an up-sample signal. The up-sample signal may be the up-sample output 228a-228n of the processing system executing functions of the up-sample module 212a-212n.

In determination block 514, the processing system may identify whether a final signal is generated. In embodiments executing optional blocks 504, 512, the processing system may identify whether a final up-sampling is complete. In embodiments not executing optional blocks 504, 512, the processing system may identify whether a final encoding is complete. In some embodiments, identifying generation of a final signal may involve the processing system tracking how many times or to which reshaping ratio r down-sampling has been implemented for the bottleneck signal 210 or the decoded signals derived, at least in part, from the bottleneck signal 210. In some embodiments, identifying generation of a final signal may involve the processing system tracking how many times decoding has been implemented for the bottleneck signal 210 or the decoded signals derived, at least in part, from the bottleneck signal 210. In some embodiments, identifying generation of a final signal may involve the processing system tracking how many times combination has been implemented for the bottleneck signal 210 or the decoded signals derived, at least in part, from the bottleneck signal 210. In some embodiments, identifying generation of a final signal may involve the processing system generating a final up-sample output 228n. In some embodiments, identifying generation of a final signal may involve the processing system generating a latent output 232n. Identification of whether a final signal is generated may be a process of the processing system executing functions of the final up-sample module 212n, the decoder module 216n, or the combination module 214n.

In response to determining that the final signal is not generated (i.e., determination block 514=“No”), the processing system may receive an encoded signal from the encoder of the deep state-space autoencoder 200a-200d in block 506. In response to determining that the final signal is generated (i.e., determination block 514=“Yes”), the processing system may receive an encoded signal from the encoder of the deep state-space autoencoder 200a, 200b in optional block 516. The encoded signal may be the latent output 224a of the processing system executing functions of the encoder module 204a. The encoded signal may be received by the deep state-space autoencoder 200a, 200b, including a combination module 214n, executed by the processing system. Receiving the encoded signal from the encoder of the deep state-space autoencoder 200a, 200b in optional block 516 may be executed by the processing system in embodiments executing optional blocks 504, 512.

In optional block 518, the processing system may combine the up-sample signal and the encoded signal. The up-sample signal and the encoded signal combined by the processing system may include data of the same reshaping ratio. In other words, the processing system may combine the up-sample signal and the encoded signal of the same degree of reshaping, or down-sampling and up-sampling. Combination of the up-sample signal and the encoded signal may be accomplished through one or more operations, such as addition to generate a final combined signal, which may be the combined output 230n. Combining the up-sample signal and the encoded signal may include the processing system executing functions of the combination module 214n. Combining the up-sample signal and the encoded signal in optional block 518 may be executed by the processing system in embodiments executing optional blocks 504, 512, 516.

In optional block 520, the processing system may decode the final combined signal. Decoding the final combined signal may include the processing system executing functions of the decoder module 216n, including functions of any combination of the modules 240, 242, 244, 246. A final decoded signal 218 may be generated by decoding the final combined signal. A final decoded signal 218 may be a latent output 232n of the processing system executing functions of a final decoder module 216n. Decoding the final combined signal in optional block 520 may be executed by the processing system in embodiments executing optional blocks 504, 512, 516, 518. Decoding the final combined signal is described further herein for the method 500b with reference to FIG. 5B.

In response to determining that the final signal is generated (i.e., determination block 514=“Yes”); or following decoding the final combined signal in optional block 520, the processing system may generate an enhanced output signal 222 in block 522. Generating the enhanced output signal 222 may include the processing system executing functions of the output modules 220, including functions of any combination of the modules 242, 244, 246. The enhanced output signal 222 may be generated by processing the final decoded signal 218. The enhanced output signal 222 may be a representation of the input signal sample 202 that is a denoised signal, a super-resolution signal, and/or a dequantized signal. Generating the enhanced output signal 222 is described further herein for the method 500b with reference to FIG. 5B.

For the method 500b, with reference to FIG. 5B, blocks 540-546 may further describe decoding the combined signal in block 510 and decoding the final combined signal in block 520. Blocks 540-546 may further describe generating the enhanced output signal 222 in block 522.

In optional block 540, the processing system may execute one or more pre-convolution layers. A pre-convolution layer may be configured to prepare or transform an input into any of the modules 216a-216n, 220 for processing by the subsequent neural networks or layers. The pre-convolution layer may be configured to facilitate processing of local temporal features. For example, the pre-convolution layer may include a depthwise 1D convolution layer with a kernel size of 3. For another example, the pre-convolution layer may be executed using a finite window or infinite window convolution. In some embodiments, the pre-convolution layer may be executed based on an input of a combined signal. In some embodiments, the pre-convolution layer may be executed based on an input of the final decoded signal 218. Executing the pre-convolution layers may generate a pre-convolution output 248. Executing the pre-convolution layers may include the processing system executing functions of the pre-convolution module 240 of the decoder module 216a-216n or the output modules 220.

In block 542, the processing system may execute an SSM. The SSM may be executed for a received input and be configured to capture long-range temporal relationships present in speech signals. In some embodiments, where the processing system executes the pre-convolution layers of the decoder module 216a-216n or the output modules 220, the SSM may be executed based on an input of the pre-convolution output 248. In some embodiments, where the processing system does not execute the pre-convolution layers of or omitted from the decoder module 216a-216n, the SSM may be executed based on an input of the combined signal. In some embodiments not executing optional blocks 504, 512, the SSM of the decoder module 216a-216n may also be executed for the received input and be configured to execute up-sampling based on an input of the pre-convolution output 248 or the combined signal. In some embodiments, where the processing system does not execute the pre-convolution layers of or omitted from the output modules 220, the SSM may be executed based on an input of the final decoded signal 218. Executing the SSM layer may generate an SSM output 250. Executing the SSM layer may include the processing system executing functions of the SSM module 242 of the decoder module 216a-216n or the output modules 220.

In optional block 544, the processing system may execute one or more normalization layers. Executing the normalization layer may normalize activations of the layers of deep state-space autoencoder 200a-200d, smoothing a loss profile or surface of the parameters of the deep state-space autoencoder 200a-200d. In some embodiments, a normalization layer may be configured for layer normalization. Layer normalization may be implemented to avoid introducing new dependencies between training cases. In some embodiments, a normalization layer may be configured for batch normalization. The normalization layer configured for batch normalization may be executed during training of the deep state-space autoencoder 200a-200d and may be omitted during inference by the deep state-space autoencoder 200a-200d. The normalization layer may be executed based on an input of the SSM output 250. Executing the normalization layers may generate a normalization output 252. Executing the normalization layers may include the processing system executing functions of the normalization module 244 of the decoder module 216a-216n or the output modules 220.

In block 546, the processing system may execute one or more linear unit layers. Executing a linear unit layer may implement a linear transformation of the inputs to the linear layer. In some embodiments, a linear unit layer may be a SiLU configured to apply a sigmoid function. In some embodiments, a linear unit layer may be a ReLU configured to apply a rectification function. The linear unit layer as a ReLU may be implemented in embodiments also implementing the normalization layer implementing batch normalization. In some embodiments, where the processing system executes the normalization layers of the decoder module 216a-216n or the output modules 220, the inputs to the linear layer may include the normalization output 252. In some embodiments, where the processing system does not execute the normalization layers of or omitted from the decoder module 216a-216n or the output modules 220, the inputs to the linear unit module 246 may include the SSM output 250. Executing the linear unit layers may generate a latent output 232a-232n or an enhanced output signal 222. Executing the linear unit layers may include the processing system executing functions of the linear unit module 246 of the decoder module 216a-216n or the output modules 220.

The use of state-space models (SSMs) within the encoder and decoder modules may provide specific technical advantages for real-time audio processing. Unlike traditional recurrent neural networks (RNNs), SSMs may capture long-range temporal dependencies in audio signals using stable linear recurrent units that support efficient parallelization during training on graphics processing units (GPUs) and streamlined sequential inference on edge devices. During inference, the SSM layers may be converted to equivalent recurrent neural network layers, enabling efficient sample-by-sample processing with minimal latency. This dual-mode operation may allow the same model architecture to benefit from parallel training efficiency while achieving low-latency real-time inference, addressing a technical challenge that has limited the deployment of deep learning models for real-time audio enhancement on resource-constrained devices.

The embodiments may include a causal processing architecture of the deep state-space autoencoder that provides technical improvements in latency reduction for real-time audio applications. By avoiding bidirectional state-space layers and implementing causal convolutions in the pre-convolution and output modules, the autoencoder may process audio samples sequentially without requiring access to future audio samples. This causal design may reduce or minimize buffering requirements for streaming audio applications, enabling audio enhancement with latencies suitable for real-time communication systems, hearing aids, and live audio processing. In some embodiments, the architecture may achieve theoretical latencies of less than 50 milliseconds, which may be within acceptable thresholds for real-time speech communication where excessive latency can disrupt natural conversation flow.

The embodiments may include skip connections between the encoder and decoder modules that improve preservation of fine-grained temporal and spectral details during the audio enhancement process. By combining encoded features with corresponding decoded features at matching reshaping ratios, the skip connections may enable the decoder to reconstruct high-fidelity audio outputs while the bottleneck modules focus on capturing global patterns and noise profiles. This architectural feature may reduce audible artifacts common in audio enhancement systems, particularly those that process raw waveforms without spectral domain representations. The hourglass structure of the autoencoder, which progressively reduces temporal resolution during encoding and restores it during decoding, may concentrate computational resources on compressed feature representations where global patterns and noise characteristics may be more efficiently captured.

The embodiments may provide technical improvements, for example, in robustness to varying noise conditions compared to traditional signal processing approaches. Traditional methods such as Wiener filtering and spectral subtraction may perform adequately in stationary noise environments but introduce audible artifacts such as musical noise in non-stationary noise scenarios. The deep state-space autoencoder, trained on diverse datasets of paired clean and noisy audio signals, may learn to model complex nonlinear relationships between noisy inputs and clean outputs without relying on assumptions about noise statistics. The integration of the deep state-space autoencoder with system-on-chip (SoC) architectures, including digital signal processors (DSPs), neural processing units (NPUs), or dedicated AI accelerators, may enable audio enhancement to be performed alongside other device functions without monopolizing processing resources or causing thermal throttling.

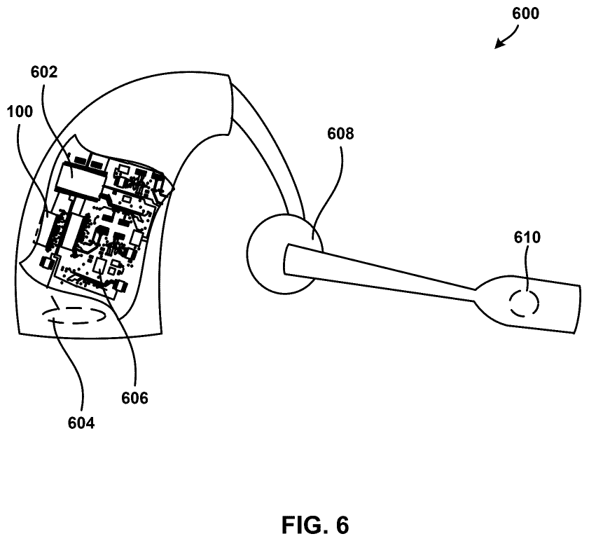

FIG. 6 is a component block diagram of an edge device 600 suitable for use with various embodiments. With reference to FIGS. 1-6, various embodiments may be implemented on a variety of edge devices, an example of which is illustrated in FIG. 6 as a wearable computing device in the form of a headset 600. A headset 600 may include a SOC 100 coupled to memory 602 (e.g., DDR4/DDR5 SDRAM, etc.), an antenna 604, a wireless transceiver 606, a speaker 608, and a microphone 610, any or all of which may be coupled to each other and/or to one or more processors 120-132 in the SOC 100. The memory 602 may include standard-performance memory, high-performance memory, volatile memory, non-volatile memory, dynamic memory, static memory, or any combination thereof (e.g., static memory and standard-performance volatile memory, etc.).

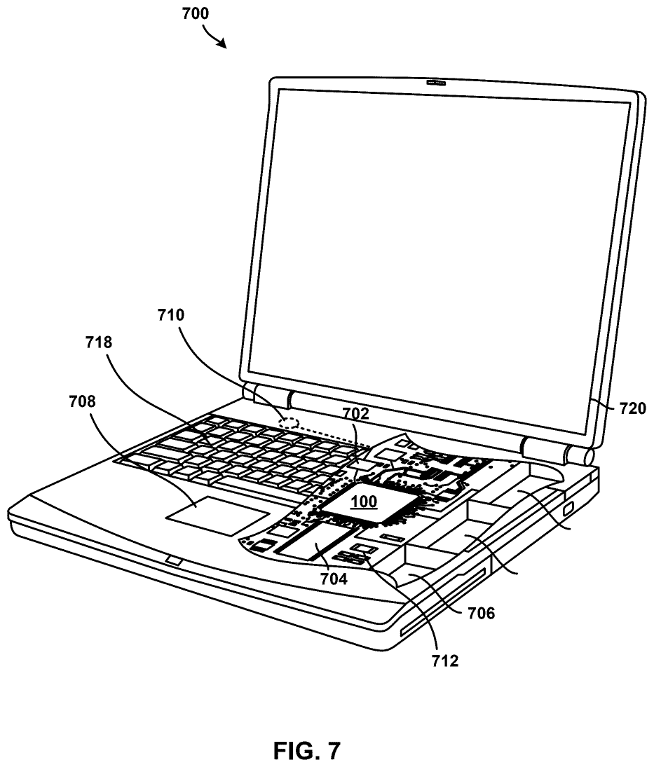

FIG. 7 is a component block diagram of an edge device 700 suitable for use with various embodiments. With reference to FIGS. 1-7, various embodiments may be implemented on a variety of edge devices, an example of which is illustrated in FIG. 7 in the form of a laptop computer 700. A laptop 700 may include a SoC 100 and/or a processor 702 coupled to a memory 704, which may include standard-performance memory, high-performance memory, volatile memory, non-volatile memory, dynamic memory, static memory, or any combination thereof. For example, memory 704 may include dynamic random-access memory (DRAM) for volatile storage and non-volatile memory such as flash or solid-state storage, such as a Non-Volatile Memory Express (NVMe) solid-state drive (SSD) 706. The laptop 700 may include multiple antennas 710 designed to support various wireless communication standards, including Wi-Fi 6/6E, 5G cellular connectivity, and Bluetooth. These antennas are connected to a wireless data link and a cellular transceiver 712, both of which are coupled to the processor 702. In addition, the laptop 700 may include a precision touchpad 708 that supports multi-touch gestures and other modern input/output peripherals, such as a backlit keyboard 718 and a high-resolution display 720 (e.g., 4K OLED or Mini-LED). The laptop 700 may also include biometric sensors for authentication, such as a fingerprint reader or facial recognition, all of which are integrated and controlled by the processor 702.

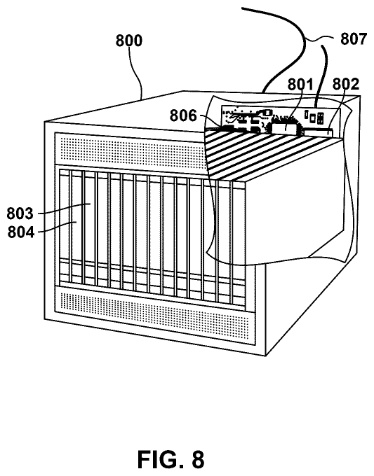

All or portions of some embodiments may be implemented in the cloud or on a variety of commercially available computing devices, such as the server computing device 800 illustrated in FIG. 8. The server device 800 may include one or more processors 801 (e.g., multi-core processor, etc.) coupled to volatile memory 802, such as RAM, and a large capacity nonvolatile memory, such as a solid-state drive (SSD) 803. The server device 800 may also include additional storage interfaces such as USB ports and NVMe slots coupled to the processor 801. The server device 800 may include network access ports 806 coupled to the processor 801 that allow data connections through a network interface card (NIC) 804 and a communication network 807 (e.g., an Internet Protocol (IP) network) connected to other network elements.

For the sake of clarity and ease of presentation, the methods discussed in this application are presented as separate embodiments. While each method is delineated for illustrative purposes, it should be clear to those skilled in the art that various combinations or omissions of these methods, blocks, operations, etc. could be used to achieve a desired result or a specific outcome. It should also be understood that the descriptions herein do not preclude the integration or adaptation of different embodiments of the methods, blocks, operations, etc. from producing a modified or alternative result or solution. The presentation of individual methods, blocks, operations, etc. should not be interpreted as mutually exclusive, limiting, or as being required unless expressly recited as such in the claims.

The processors discussed in this application may be any programmable microprocessor, microcomputer, or a combination of multiple processor chips configured by software instructions (applications) to perform diverse functions, including those of the various embodiments described herein. Servers often include multiple processors, with dedicated processors for specific tasks such as managing cloud computing operations, data analytics, or wireless communication functions. Software applications may be stored in the internal memory before being accessed and executed by the processor. Modern processors may include extensive internal memory, often augmented with fast access cache memory, to efficiently store and process application software instructions.

Implementation examples are described in the following paragraphs. While some of the following implementation examples are described in terms of example methods, further example implementations may include: the example methods discussed in the following paragraphs implemented by a computing system including a processor configured (e.g., with processor-executable instructions) to perform operations of the methods of the following implementation examples; the example methods discussed in the following paragraphs implemented by a computing system including means for performing functions of the methods of the following implementation examples; the example methods discussed in the following paragraphs may be implemented as a non-transitory processor-readable storage medium having stored thereon processor-executable instructions configured to cause a processor of a computing system to perform the operations of the methods of the following implementation examples; and the example methods discussed in the following paragraphs may be implemented as a non-transitory processor-readable storage medium having stored thereon data and configurations to control a state machine or cause a processor to perform the operations of the methods of the following implementation examples.
Example 1: A method performed by at least one processor in a processing system of an edge device for online audio enhancement may include encoding an input signal by an encoder of a deep state-space autoencoder based in part on executing a first state-space model (SSM) to generate a first encoded signal. The method may include decoding a signal derived in part from the first encoded signal by a decoder of the deep state-space autoencoder based in part on executing a second SSM to generate a first decoded signal. The method may include processing the first decoded signal through a postprocessing layer to generate an enhanced output signal. The method may include preserving temporal and spatial details by integrating skip connections from the encoder to the decoder during the decoding operations.
Example 2: In some embodiments of Example 1, the method may further include combining the first encoded signal with a second decoded signal of a corresponding reshaping ratio to generate a first combined signal, wherein decoding the signal derived in part from the first encoded signal may include decoding the first combined signal.
Example 3: In some embodiments of Example 2, combining the first encoded signal with the second decoded signal of the corresponding reshaping ratio to generate the first combined signal may include combining the first encoded signal with a first up-sample signal of the corresponding reshaping ratio to generate the first combined signal, wherein the first up-sample signal is derived from the second decoded signal.
Example 4: In some embodiments of Example 2, the method may further include generating a second encoded signal by encoding the first encoded signal by the encoder of the deep state-space autoencoder based in part on executing a third SSM. The method may include generating a second combined signal by combining the second encoded signal with a third decoded signal of a corresponding reshaping ratio. The method may include generating the second decoded signal by decoding the second combined signal by the decoder of the deep state-space autoencoder based in part on executing a fourth SSM.
Example 5: In some embodiments of Example 4, the method may further include generating a first down-sample signal by down-sampling the first encoded signal. Generating the second encoded signal by encoding the first encoded signal may include generating the second encoded signal by encoding the first down-sample signal by the encoder of the deep state-space autoencoder based in part on executing the third SSM. Generating the second combined signal by combining the second encoded signal with the third decoded signal of the corresponding reshaping ratio may include generating the second combined signal by combining the second encoded signal with a second up-sample signal of the corresponding reshaping ratio, wherein the second up-sample signal is derived from a third decoded signal.
Example 6: In some embodiments of Example 1, the method may further include generating a second encoded signal by encoding a third encoded signal by the encoder of the deep state-space autoencoder based in part on executing a third SSM, wherein the third encoded signal is derived from the input signal. The method may include generating a bottleneck signal by processing the second encoded signal through a bottleneck layer based in part on executing a fourth SSM. The method may include generating a first combined signal by combining the second encoded signal and the bottleneck signal of the same reshaping ratio. The method may include generating a second decoded signal by decoding the first combined signal by the decoder of the deep state-space autoencoder based in part on executing a fifth SSM.
Example 7: In some embodiments of Example 6 to generate the second encoded signal by encoding the third encoded signal may include generating the second encoded signal by encoding a first down-sampled signal by the encoder of the deep state-space autoencoder based in part on executing the third SSM, wherein the first down-sampled signal is derived from the third encoded signal. The method may further include generating a second down-sampled signal by down-sampling the second encoded signal, wherein generating the bottleneck signal by processing the second encoded signal may include generating the bottleneck signal by processing the second down-sampled signal through the bottleneck layer based in part on executing the fourth SSM. The method may include up-sampling the bottleneck signal to generate a first up-sample signal, wherein generating the first combined signal by combining the second encoded signal and the bottleneck signal of the same reshaping ratio may include generating the first combined signal by combining the second encoded signal and the first up-sample signal of the same reshaping ratio.
Example 8: In some embodiments of Example 1, encoding the input signal by the encoder of the deep state-space autoencoder based in part on executing the first SSM to generate the first encoded signal may include generating a pre-convolution output by transforming the input signal by the encoder based on executing a pre-convolution layer. The encoding may include generating an SSM output by capturing long-range temporal relationships present in the input signal by the encoder based on executing the first SSM using the pre-convolution output. The encoding may include generating a normalization output by normalizing activations of the deep state-space autoencoder by the encoder based on executing a normalization layer using the SSM output. The encoding may include generating the first encoded signal by performing a linear transformation of the normalization output by the encoder based on executing a linear unit layer using the normalization output.
Example 9: In some embodiments of Example 1, decoding the signal derived in part from the first encoded signal by the decoder of the deep state-space autoencoder based in part on executing the second SSM to generate the first decoded signal may include generating an SSM output by capturing long-range temporal relationships in the signal by the decoder based on executing the second SSM using the signal. The decoding may include generating a normalization output by normalizing activations of the deep state-space autoencoder by the decoder based on executing a normalization layer using the SSM output. The decoding may include generating the first decoded signal by executing a linear transformation of the normalization output by the decoder based on executing a linear unit layer using the normalization output.
Example 10: In some embodiments of Example 1, processing the first decoded signal through the postprocessing layer to generate the enhanced output signal may include applying causal convolution to the first decoded signal to reduce forward-looking latency and generate the enhanced output signal.
Example 11: In some embodiments of Example 1, the input signal and the enhanced output signal may be raw audio signals in a time domain.
Example 12: In some embodiments of Example 1, the input signal may be a frequency domain audio signal transformed based on a raw audio signal in a time domain and the enhanced output signal may be a frequency domain audio signal.
Example 13: In some embodiments of Example 1, the enhanced output signal may be a representation of the input signal that is at least one of a denoised audio signal, a super-resolution audio signal, and a de-quantized audio signal.
Example 14: A method performed by at least one processor in a processing system of an edge device for online audio enhancement may include encoding a first plurality of encoded signals by an encoder of a deep state-space autoencoder based in part on executing a first plurality of state-space models (SSMs) to generate a second plurality of encoded signals, wherein at least one of the second plurality of encoded signals is at least one of the first plurality of encoded signals. The method may include combining the first plurality of encoded signals with a first plurality of decoded signals to generate a first plurality of combined signals. The method may include decoding the first plurality of combined signals by a decoder of the deep state-space autoencoder based in part on executing a second plurality of SSMs to generate a second plurality of decoded signals, wherein at least one of the second plurality of decoded signals is at least one of the first plurality of decoded signals.
Example 15: In some embodiments of Example 14, the method may further include encoding an input signal by the encoder of the deep state-space autoencoder based in part on executing a first SSM to generate a first encoded signal. The method may include combining the first encoded signal with a decoded signal of the second plurality of decoded signals to generate a final combined signal. The method may include decoding the final combined signal by the decoder of the deep state-space autoencoder based in part on executing the second SSM to generate a final decoded signal. The method may include generating an enhanced output signal based in part on executing a third SSM based on the final decoded signal.
Example 16: In some embodiments of Example 15, combining the first encoded signal with the decoded signal of the second plurality of signals to generate the final combined signal may include combining the first encoded signal with a final up-sample signal derived from the decoded signal to generate the final combined signal.
Example 17: In some embodiments of Example 14, the method may further include down-sampling the first plurality of encoded signals to generate a first plurality of down-sample signals, wherein encoding the first plurality of encoded signals by the encoder of the deep state-space autoencoder based in part on executing the first plurality of SSMs to generate the second plurality of encoded signals may include encoding the first plurality of down-sample signals by the encoder of the deep state-space autoencoder based in part on executing the first plurality of SSMs to generate the second plurality of encoded signals. The method may include up-sampling the first plurality of decoded signals to generate a first plurality of up-sample signals, wherein combining the first plurality of encoded signals with the first plurality of decoded signals to generate the first plurality of combined signals may include combining the first plurality of encoded signals with a first plurality of up-sample signals to generate the first plurality of combined signals.
Example 18: In some embodiments of Example 14, the method may further include processing a final encoded signal of the second plurality of encoded signals through a bottleneck layer based in part on executing a first SSM to generate a bottleneck signal. The method may include combining the final encoded signal and the bottleneck signal to generate a first combined signal. The method may include decoding the first combined signal by the decoder of the deep state-space autoencoder based in part on executing an SSM of the second plurality of SSMs to generate a first decoded signal of the second plurality of decoded signals.
Example 19: In some embodiments of Example 18, the method may further include down-sampling the final encoded signal of the second plurality of encoded signals to generate a final down-sample signal, wherein processing the final encoded signal of the second plurality of encoded signals through the bottleneck layer based in part on executing the first SSM to generate the bottleneck signal may include processing the final down-sample signal through the bottleneck layer based in part on executing the first SSM to generate the bottleneck signal. The method may include up-sampling the bottleneck signal to generate a first up-sample signal, wherein combining the final encoded signal and the bottleneck signal to generate the first combined signal may include combining the final encoded signal and the first up-sample signal to generate the first combined signal.
Example 20: A method performed by at least one processor in a processing system of an edge device for online audio enhancement may include receiving a noisy input audio signal, wherein the noisy input audio signal is sampled at an input sampling rate. The method may include encoding the noisy input audio signal, using an encoder including a first encoder block, to generate first encoded audio features, wherein the first encoder block includes at least one state-space model (SSM) layer configured to capture long-range temporal dependencies. The method may include down-sampling encoded audio features to generate down-sampled audio features, wherein the down-sampling adjusts a temporal resolution and a channel dimension of the preprocessed audio features based on a reshaping ratio, wherein the encoded audio features includes the first encoded audio features. The method may include encoding first down-sampled audio features of the down-sampled audio features, using the encoder further including a plurality of encoder blocks, to generate second encoded audio features, wherein the encoded audio features further includes the second encoded audio features and wherein each encoder block of the plurality of encoder blocks includes at least one SSM layer configured to capture long-range temporal dependencies and each encoder block of the plurality of encoder blocks adjusts the temporal resolution and the channel dimension of the audio features based on a respective reshaping ratio. The method may include processing second down-sampled audio features of the down-sampled audio features through a bottleneck layer that includes at least one SSM layer configured to refine the second down-sampled audio features without further adjusting the temporal resolution or the channel dimension to generate bottleneck features. The method may include decoding the bottleneck features and the encoded audio features, using a decoder including a plurality of decoder blocks, to generate decoded audio features including final decoded audio features, wherein each decoder block includes at least one SSM layer configured to reconstruct long-range temporal dependencies, each decoder block adjusts the temporal resolution and the channel dimension of the encoded audio features based on a reshaping ratio corresponding to the reshaping ratio applied by a corresponding encoder block, and each decoder block receives skip connections from the corresponding encoder block to preserve spatial and temporal details. The method may include up-sampling the decoded audio features, wherein the up-sampling restores the temporal resolution and the channel dimension of the noisy input audio signal. The method may include processing the final decoded audio features through an output layer that applies at least one causal convolution to refine the up-sampled audio features and reduce latency. The method may include outputting an enhanced audio signal that is denoised and conforms to an output sampling rate.
Example 21: In some embodiments of Example 20, the method may further include combining the encoded audio features with up-sampled audio features of corresponding reshaping ratios to generate combined audio features, wherein decoding the encoded audio features may include decoding the combined audio features, using the decoder, to generate decoded audio features.
Example 22: In some embodiments of Example 21, the method may further include down-sampling the encoded audio features iteratively to generate the down-sampled audio features. The method may include up-sampling the decoded audio features iteratively to generate the up-sampled audio features, wherein the down-sampling and up-sampling are performed using predefined reshaping ratios.
Example 23: In some embodiments of Example 20, encoding the down-sampled audio features may include generating an SSM output by capturing long-range temporal relationships in the down-sampled audio features using an SSM layer. The encoding may include at least one of generating a pre-convolution output by applying the preprocessing layer to generate a normalized output by normalizing activations of the encoder using a normalization layer, and generating the encoded audio features by performing a linear transformation of the normalized output using a linear unit layer.
Example 24: In some embodiments of Example 20, the method may further include performing super-resolution by encoding a down-sampled and quantized input signal and outputting an enhanced audio signal that approximates the original audio signal at the predetermined sampling rate.
Example 25: In some embodiments of Example 20, the method may further include configuring the SSM layers with trainable parameters to model long-range temporal dependencies. The method may include training the SSM layers using a Fourier-transform-based convolution technique to enhance a frequency-domain representation of audio features. The method may include converting the SSM layers into equivalent recurrent neural network layers during inference to reduce latency.
Example 26: In some embodiments of Example 20, the method may further include applying a loss function during training, wherein the loss function combines SmoothL1 loss and spectral loss measured at an equivalent rectangular bandwidth (ERB) scale.
Example 27: A method performed by at least one processor in a processing system of an edge device for enhancing speech signals may include receiving a noisy input audio signal, wherein the noisy input audio signal is sampled at a predetermined sampling rate. The method may include encoding, by an encoder including a first encoder block, the noisy input audio signal to generate first encoded audio features, wherein the first encoder block applies at least one state-space model (SSM) layer to capture long-range temporal dependencies. The method may include progressively down-sampling a plurality of encoded audio features, and encoding a plurality of down-sampled audio features by down-sampling the first encoded audio features and then a plurality of subsequent encoded audio features as each of the plurality of subsequent encoded audio features is generated to generate the plurality of down-sampled audio features and final down-sampled audio features, wherein the down-sampling adjusts a temporal resolution and a channel dimension of the first encoded audio features and the plurality of subsequent encoded audio features based on a predefined reshaping ratio corresponding to each instance of down-sampling, and encoding, by the encoder further including a plurality of subsequent encoder blocks, the plurality of down-sampled audio features to generate the plurality of subsequent encoded audio features and final encoded audio features, wherein each subsequent encoder block applies at least one SSM layer to capture long-range temporal dependencies. The method may include processing the final down-sampled audio features through a bottleneck layer that includes at least one SSM layer configured to refine the final down-sampled audio features to generate bottleneck audio features. The method may include up-sampling the bottleneck audio features to generate first up-sampled audio features, wherein the up-sampling adjusts a temporal resolution and a channel dimension of the bottleneck audio features based on a reshaping ratio to a reshaping ratio used to generate the final down-sampled audio features. The method may include progressively receiving the plurality of encoded audio features, combining the plurality of encoded audio features and a plurality of up-sampled audio features including the first up-sampled audio features and a plurality of subsequent up-sampled audio features and decoding a plurality of combined audio features by receiving, at the decoder, the plurality of encoded audio features via skip connections from a corresponding encoder block to preserve spatial and temporal details, combining the plurality of encoded audio features and the plurality of up-sampled audio features as each of the plurality of up-sampled audio features is generated to generate the plurality of combined audio features, wherein the encoded audio features and the up-sampled audio features that are combined are generated based on corresponding reshaping ratios, decoding, by a decoder including a plurality of decoder blocks, the plurality of combined audio features as each of the plurality of combined audio features is generated to generate a plurality of decoded audio features including final decoded audio features, wherein each decoder block applies at least one SSM layer to reconstruct temporal dependencies, and up-sampling the plurality of decoded audio features as each of the plurality of decoded audio features is generated to generate the plurality of up-sampled audio features based on the corresponding inverse reshaping ratios. The method may include processing the final decoded audio features through an output layer that includes at least one SSM layer configured to refine the final decoded audio features to generate an enhanced audio signal. The method may include outputting the enhanced audio signal that is denoised.
Example 28: In some embodiments of Example 27, the method may further include configuring the SSM layer to model long-range temporal dependencies, wherein the SSM layer includes a set of trainable parameters. The method may include training the SSM layer using a Fourier-transform-based convolution technique that enhances a frequency-domain representation of audio features enabling parallelized kernel operations. The method may include converting the SSM layer to an equivalent recurrent neural network layer during inference to reduce latency.
Example 29: In some embodiments of Example 27, encoding the plurality of down-sampled audio features may include processing the plurality of down-sampled audio features through a preprocessing layer that applies a depthwise one-dimensional convolution to extract the local temporal features. The encoding may include configuring a kernel size for the depthwise convolution to align with a predefined temporal feature window.
Example 30: In some embodiments of Example 27, the encoder and decoder may be configured to process raw audio waveforms without applying spectral domain transformations.
Example 31: In some embodiments of Example 27, the method may further include performing super-resolution on the noisy input audio signal, wherein the noisy input audio signal is intentionally down-sampled and quantized prior to encoding. The method may include retraining the encoder and decoder to handle the down-sampled and quantized input. The method may include outputting an enhanced audio signal that approximates an original audio signal at the predetermined sampling rate and amplitude range.
Example 32: In some embodiments of Example 27, the bottleneck layer may retain a fixed temporal resolution and channel dimension while refining the encoded audio features.
Example 33: In some embodiments of Example 27, the method may further include applying a reshaping ratio for each encoder block and decoder block, wherein a product of the reshaping ratios defines theoretical latency of the method. The method may include enhancing the configuration of each encoder block and decoder block to reduce latency while maintaining real-time inference capabilities.
Example 34: In some embodiments of Example 27, the method may further include applying a loss function during training, wherein the loss function combines SmoothL1 loss and spectral loss measured at an equivalent rectangular bandwidth (ERB) scale.
Example 35: A computing device may have a processor configured with processor-executable instructions to perform various operations corresponding to any of the methods of Examples 1-34.
Example 36: A computing device may have various means for performing functions corresponding to any of the methods in any of Examples 1-34.
Example 37: A non-transitory processor-readable storage medium may have stored thereon processor-executable instructions configured to cause a processor to perform various operations corresponding to any of the methods in any of Examples 1-34.
Example 38: A non-transitory processor-readable storage medium may have stored thereon data and configurations to control a state machine or cause a processor to perform various operations corresponding to any of the methods in any of Examples 1-34.
Example 39: In some embodiments of Example 1, the deep state-space autoencoder may be implemented on a system-on-chip (SoC) of the edge device including at least one of a digital signal processor (DSP), a neural processing unit (NPU), or an artificial intelligence (AI) processor, and wherein the enhanced output signal is generated in real-time with a latency of less than 50 milliseconds.
Example 40: In some embodiments of Example 1, the encoding and decoding may be performed using fewer than 1 million parameters and fewer than 0.5 billion multiply-accumulate (MAC) operations per second, enabling real-time audio enhancement on the edge device without requiring spectral domain transformations.
Example 41: In some embodiments of Example 15, the enhanced output signal is provided to at least one of a speaker, a hearing aid, an automatic speech recognition system, or a telecommunication interface of the edge device in real-time for immediate playback or further processing.
Example 42: In some embodiments of Example 30, the input signal may include a raw audio waveform in a time-domain representation, and wherein the encoder and decoder process the raw audio waveform directly without applying short-time Fourier transforms (STFTs) or inverse STFTs, thereby reducing computational overhead and power consumption on the edge device.
Example 43: In some embodiments of Example 1, the first SSM and the second SSM may be configured as causal state-space models that avoid bidirectional processing, and the processing through the postprocessing layer may include applying causal convolution, such that the method processes audio samples sequentially without requiring future audio samples, enabling real-time streaming audio enhancement with reduced buffering requirements.
Example 44: In some embodiments of Example 1, the method may be performed by a processing system of the edge device selected from a wearable device, a hearing aid, a smartphone, a laptop, or an Internet of Things (IoT) device, and the enhanced output signal may improve intelligibility of speech content in the presence of non-stationary background noise.
Example 45: In some embodiments of Example 1, the deep state-space autoencoder may be configured to capture long-range temporal dependencies in the input signal using stable linear recurrent units of the first SSM and the second SSM, and the method may achieve a perceptual evaluation of speech quality (PESQ) score improvement while consuming less power than methods requiring spectral domain transformations, thereby providing a technical improvement in audio enhancement for resource-constrained edge devices.

As used in this application, terminology such as “component,” “module,” “system,” etc., is intended to encompass a computer-related entity. These entities may involve, among other possibilities, hardware, firmware, a blend of hardware and software, software alone, or software in an operational state. As examples, a component may encompass a running process on a processor, the processor itself, an object, an executable file, a thread of execution, a program, or a computing device. To illustrate further, both an application operating on a computing device and the computing device itself may be designated as a component. A component might be situated within a single process or thread of execution or could be distributed across multiple processors or cores. In addition, these components may operate based on various non-volatile computer-readable media that store diverse instructions and/or data structures. Communication between components may take place through local or remote processes, function, or procedure calls, electronic signaling, data packet exchanges, memory interactions, among other known methods of network, computer, processor, or process-related communications.

A variety of memory types and technologies, both currently available and anticipated for future development, may be incorporated into systems and computing devices that implement the various embodiments. These memory technologies may include non-volatile random-access memories (NVRAM) such as magnetoresistive RAM (MRAM), resistive random-access memory (ReRAM or RRAM), phase-change memory (PCM, PC-RAM, or PRAM), ferroelectric RAM (FRAM), spin-transfer torque magnetoresistive RAM (STT-MRAM), and three-dimensional cross point (3D XPoint) memory. Non-volatile or read-only memory (ROM) technologies may also be included, such as programmable read-only memory (PROM), field programmable read-only memory (FPROM), and one-time programmable non-volatile memory (OTP NVM). Volatile random-access memory (RAM) technologies may further be utilized, including dynamic random-access memory (DRAM), double data rate synchronous dynamic random-access memory (DDR SDRAM), static random-access memory (SRAM), and pseudostatic random-access memory (PSRAM). Additionally, systems and computing devices implementing these embodiments may use solid-state non-volatile storage mediums, such as FLASH memory. The aforementioned memory technologies may store instructions, programs, control signals, and/or data for use in computing devices, system-on-chip (SoC) components, or other electronic systems. Any references to specific memory types, interfaces, standards, or technologies are provided for illustrative purposes and do not limit the claims to any particular memory system or technology unless explicitly recited in the claim language.

The foregoing method descriptions and the process flow diagrams are provided merely as illustrative examples and are not intended to require or imply that the blocks of the various aspects must be performed in the order presented. As may be appreciated by one of skill in the art the order of steps in the foregoing aspects may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithmic steps described in connection with the aspects disclosed herein may be implemented as electronic hardware, computer software, or combinations of both. To clearly illustrate the interchangeability of hardware and software, various components, blocks, modules, circuits, and steps have been described in terms of their functionality. Whether such functionality is implemented as hardware or software may depend on the specific application and the design constraints of the overall system. Skilled artisans may implement the described functionality in different ways for each particular application, and such implementation decisions should not be interpreted as limiting or altering the scope of the claims unless explicitly recited in the claim language.

The hardware used to implement the various illustrative logics, logical blocks, modules, and circuits described in connection with the embodiments disclosed herein may include or be performed by a general-purpose processor, a digital signal processor (DSP), an application-specific integrated circuit (ASIC), a field-programmable gate array (FPGA), a graphics processing unit (GPU), a tensor processing unit (TPU), or other programmable logic devices, discrete gate or transistor logic, discrete hardware components, or any combination thereof, designed to perform the functions described. A general-purpose processor may be a microprocessor, or alternatively, it may be any conventional processor, controller, microcontroller, or state machine. A processor may also be implemented as a combination of computing devices, such as a DSP combined with a microprocessor, multiple microprocessors, one or more microprocessors used in conjunction with a DSP core, a GPU, or AI accelerators such as TPUs. Alternatively, some operations or methods may be performed by circuitry designed specifically for a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module that resides on a non-transitory computer-readable or processor-readable storage medium. Non-transitory computer-readable or processor-readable storage media include any storage media that may be accessed by a computer or processor. By way of example, but not limitation, such non-transitory computer-readable or processor-readable media may include RAM, ROM, EEPROM, flash memory, SSDs, NVMe drives, 3D NAND flash, or any other medium capable of storing program code in the form of instructions or data structures that may be accessed by a computer. Cloud-based storage solutions, including infrastructure-as-a-service (IaaS) platforms, may provide scalable and distributed options for storing and accessing program code. In addition, the operations of a method or algorithm may reside as one or more sets of instructions or code on a non-transitory processor-readable or computer-readable medium, which may be incorporated into a computer program product. Emerging technologies, such as quantum computing storage media and blockchain-based storage solutions, may enhance data integrity and security. AI and ML-improved hardware accelerators, such as GPUs, TPUs, and other dedicated processing units, may be used to efficiently execute complex algorithms.

The preceding description of the disclosed aspects is provided to enable any person skilled in the art to make or use the claims. Various modifications to these aspects may be apparent to those skilled in the art, and the generic principles defined herein may be applied to other aspects without departing from the scope of the claims. Thus, the present disclosure is not intended to be limited to the aspects shown herein but is to be accorded the widest scope consistent with the following claims and the principles and novel features disclosed herein.

What is claimed is:

1. A method performed by at least one processor in a processing system of an edge device for online audio enhancement, the method comprising:
receiving an input audio signal;
generating a first encoded signal by executing an encoder of a deep state-space autoencoder, including executing a first state-space model (SSM) layer to transform the input audio signal;
generating a first decoded signal by executing a decoder of the deep state-space autoencoder, including executing a second SSM layer to transform a signal derived from the first encoded signal; and
generating an enhanced output audio signal by processing the first decoded signal with a postprocessing layer.

2. The method of claim 1, further comprising:
generating the signal derived from the first encoded signal as a first combined signal by combining the first encoded signal with a second decoded signal having a temporal resolution matching the first encoded signal; and
generating the first decoded signal by decoding the first combined signal.

3. The method of claim 2, further comprising:
generating a first up-sample signal by up-sampling the second decoded signal to a temporal resolution matching the first encoded signal; and
generating the first combined signal by combining the first encoded signal with the first up-sample signal.

4. The method of claim 2, further comprising:
generating a second encoded signal by encoding the first encoded signal by executing the encoder including executing a third SSM layer;
generating a second combined signal by combining the second encoded signal with a third decoded signal having a temporal resolution matching the second encoded signal; and
generating the second decoded signal by decoding the second combined signal by executing the decoder including executing a fourth SSM layer.

5. The method of claim 4, further comprising:
generating a first down-sample signal by down-sampling the first encoded signal;
generating the second encoded signal by encoding the first down-sample signal;
generating a second up-sample signal by up-sampling the third decoded signal to a temporal resolution matching the second encoded signal; and
generating the second combined signal by combining the second encoded signal with the second up-sample signal.

6. The method of claim 1, further comprising:
generating a second encoded signal by encoding the first encoded signal by executing the encoder including executing a third SSM layer;
generating a bottleneck signal by processing the second encoded signal with a bottleneck layer including executing a fourth SSM layer;
generating a bottleneck combined signal by combining the second encoded signal with the bottleneck signal at a matching temporal resolution; and
generating a second decoded signal by decoding the bottleneck combined signal by executing the decoder including executing a fifth SSM layer.

7. The method of claim 6, further comprising:
generating a first down-sampled signal by down-sampling the first encoded signal;
generating the second encoded signal by encoding the first down-sampled signal;
generating a second down-sampled signal by down-sampling the second encoded signal;
generating the bottleneck signal by processing the second down-sampled signal with the bottleneck layer;
generating a first up-sample signal by up-sampling the bottleneck signal to a temporal resolution matching the second encoded signal; and
generating the bottleneck combined signal by combining the second encoded signal with the first up-sample signal.

8. The method of claim 1, further comprising:
generating a pre-convolution output by filtering the input audio signal with a pre-convolution layer executed by the encoder;
generating an encoder SSM output by executing the first SSM layer on the pre-convolution output;
generating an encoder normalization output by normalizing activations with a normalization layer executed by the encoder on the encoder SSM output; and
generating the first encoded signal by applying a linear unit layer executed by the encoder to the encoder normalization output.

9. The method of claim 1, further comprising:
generating a decoder SSM output by executing the second SSM layer on the signal derived from the first encoded signal;
generating a decoder normalization output by normalizing activations with a normalization layer executed by the decoder on the decoder SSM output; and
generating the first decoded signal by applying a linear unit layer executed by the decoder to the decoder normalization output.

10. The method of claim 1, further comprising generating the enhanced output audio signal by filtering the first decoded signal with a causal convolution executed by the postprocessing layer to reduce forward-looking latency.

11. The method of claim 1, further comprising:
representing the input audio signal as a raw time-domain waveform; and
representing the enhanced output audio signal as a raw time-domain waveform.

12. The method of claim 1, further comprising:
representing the input audio signal as a frequency-domain representation derived from a raw time-domain waveform; and
representing the enhanced output audio signal as a frequency-domain representation.

13. The method of claim 1, further comprising outputting the enhanced output audio signal as at least one of:
a denoised audio signal,
a super-resolution audio signal, or
a dequantized audio signal.

14. A computing device, comprising:
a processing system configured to:
receive an input audio signal;
generate a first encoded signal by executing an encoder of a deep state-space autoencoder, including executing a first state-space model (SSM) layer to transform the input audio signal;
generate a first decoded signal by executing a decoder of the deep state-space autoencoder, including executing a second SSM layer to transform a signal derived from the first encoded signal; and
generate an enhanced output audio signal by processing the first decoded signal with a postprocessing layer.

15. A non-transitory processor-readable medium having stored thereon stored thereon data, configurations, or processor-readable instructions to control a state machine or cause a processing system in a computing device to perform operations for online audio enhancement the operations comprising:
receiving an input audio signal;
generating a first encoded signal by executing an encoder of a deep state-space autoencoder, including executing a first state-space model (SSM) layer to transform the input audio signal;
generating a first decoded signal by executing a decoder of the deep state-space autoencoder, including executing a second SSM layer to transform a signal derived from the first encoded signal; and
generating an enhanced output audio signal by processing the first decoded signal with a postprocessing layer.

16. A method performed by at least one processor in a processing system of an edge device for online audio enhancement, the method comprising:
receiving an input audio signal comprising a time-ordered sequence of audio sample values;
generating encoded audio features by executing an encoder of a deep state-space autoencoder, including maintaining a first hidden state of a first state-space model (SSM) layer having a fixed state dimension and updating the first hidden state based on successive audio sample values;
storing at least a portion of the encoded audio features as a skip connection feature set;
generating decoder input features by transforming the encoded audio features;
generating decoded audio features by executing a decoder of the deep state-space autoencoder, including maintaining a second hidden state of a second SSM layer having a fixed state dimension and updating the second hidden state based on successive decoder input feature values;
generating combined decoded audio features by combining the skip connection feature set with a decoded audio feature subset having a temporal resolution matching the skip connection feature set; and
generating an enhanced output audio signal by processing the combined decoded audio features with a postprocessing layer including a causal convolution to output a time-ordered sequence of enhanced audio sample values.

17. The method of claim 16, further comprising:
generating down-sampled encoded audio features by down-sampling the encoded audio features according to a resampling factor;
generating bottleneck audio features by processing the down-sampled encoded audio features with a bottleneck layer of the deep state-space autoencoder;
generating up-sampled bottleneck audio features by up-sampling the bottleneck audio features according to an inverse resampling factor corresponding to the resampling factor; and
assigning the up-sampled bottleneck audio features as the decoder input features.

18. The method of claim 17, further comprising:
generating a plurality of encoded audio feature sequences at a plurality of temporal resolutions by iteratively down-sampling and encoding within a plurality of encoder blocks of the encoder;
generating a plurality of skip connection feature sets by storing a respective skip connection feature set from each encoded audio feature sequence of the plurality of encoded audio feature sequences;
generating a plurality of decoded audio feature sequences at the plurality of temporal resolutions by iteratively up-sampling and decoding within a plurality of decoder blocks of the decoder; and
generating the combined decoded audio features by combining, for each temporal resolution of the plurality of temporal resolutions, a respective skip connection feature set with a respective decoded audio feature sequence.

19. The method of claim 16, further comprising generating the combined decoded audio features by performing an elementwise addition operation between the skip connection feature set and the decoded audio feature subset.

20. The method of claim 16, further comprising:
generating a pre-convolution output by filtering the sequence of audio sample values with a depthwise one-dimensional causal convolution; and
generating the encoded audio features by providing the pre-convolution output to the first SSM layer.

21. The method of claim 16, further comprising:
generating a state-space output by executing the first SSM layer while generating the encoded audio features;
generating a normalized state-space output by normalizing the state-space output with a normalization layer; and
generating the encoded audio features by applying a linear unit layer to the normalized state-space output.

22. The method of claim 21, further comprising generating the normalized state-space output by performing layer normalization on the state-space output.

23. The method of claim 16, further comprising:
maintaining the first hidden state as a complex-valued state vector;
generating a real-valued state-space output by extracting a real component of the complex-valued state vector; and
generating the encoded audio features by processing the real-valued state-space output.

24. The method of claim 16, further comprising:
representing the input audio signal as a time-domain waveform;
representing the enhanced output audio signal as a time-domain waveform; and
omitting a short-time Fourier transform and an inverse short-time Fourier transform.

25. The method of claim 16, further comprising:
representing the input audio signal as a frequency-domain representation derived from a time-domain waveform; and
representing the enhanced output audio signal as a frequency-domain representation.

26. The method of claim 16, further comprising outputting the enhanced output audio signal as at least one of:
a denoised audio signal,
a super-resolution audio signal, or
a dequantized audio signal.

27. The method of claim 16, further comprising:
identifying an input sampling rate of the input audio signal; and
generating the enhanced output audio signal at an output sampling rate higher than the input sampling rate.

28. The method of claim 16, further comprising:
identifying an input bit depth of the input audio signal;
generating decoded input values by decoding mu-law companded values of the input audio signal to linear amplitude values;
generating normalized input sample values by scaling the decoded input values to a normalized amplitude range;
assigning the normalized input sample values as the sequence of audio sample values; and
generating the sequence of enhanced audio sample values with an output bit depth higher than the input bit depth.

29. A computing device, comprising:
a processing system configured to:
receive an input audio signal comprising a time-ordered sequence of audio sample values;
generate encoded audio features by executing an encoder of a deep state-space autoencoder, including maintaining a first hidden state of a first state-space model (SSM) layer having a fixed state dimension and updating the first hidden state based on successive audio sample values;
store at least a portion of the encoded audio features as a skip connection feature set;
generate decoder input features by transforming the encoded audio features;
generate decoded audio features by executing a decoder of the deep state-space autoencoder, including maintaining a second hidden state of a second SSM layer having a fixed state dimension and updating the second hidden state based on successive decoder input feature values;
generate combined decoded audio features by combining the skip connection feature set with a decoded audio feature subset having a temporal resolution matching the skip connection feature set; and
generate an enhanced output audio signal by processing the combined decoded audio features with a postprocessing layer including a causal convolution to output a time-ordered sequence of enhanced audio sample values.

30. A non-transitory processor-readable medium having stored thereon stored thereon data, configurations, or processor-readable instructions to control a state machine or cause a processing system in a computing device to perform operations for online audio enhancement the operations comprising:
receiving an input audio signal comprising a time-ordered sequence of audio sample values;
generating encoded audio features by executing an encoder of a deep state-space autoencoder, including maintaining a first hidden state of a first state-space model (SSM) layer having a fixed state dimension and updating the first hidden state based on successive audio sample values;
storing at least a portion of the encoded audio features as a skip connection feature set;
generating decoder input features by transforming the encoded audio features;
generating decoded audio features by executing a decoder of the deep state-space autoencoder, including maintaining a second hidden state of a second SSM layer having a fixed state dimension and updating the second hidden state based on successive decoder input feature values;
generating combined decoded audio features by combining the skip connection feature set with a decoded audio feature subset having a temporal resolution matching the skip connection feature set; and
generating an enhanced output audio signal by processing the combined decoded audio features with a postprocessing layer including a causal convolution to output a time-ordered sequence of enhanced audio sample values.
